(19) United States
(12) Patent Application Publication
(10) Pub. No.: US 2024/0064197 A1
(43) Pub. Date: Feb. 22, 2024

(54) Prioritising Network Function Nodes

(71) Applicant: Telefonaktiebolaget LM Ericsson (publ), Stockholm (SE)

(72) Inventors: Maria Cruz Bartolome Rodrigo, Madrid (ES); Xin Yu Zhang, Stockholm (SE); Yunjie Lu, Shanghai (CN); Emiliano Merino Vazquez, Madrid (ES)

(21) Appl. No.: 18/266,942

(22) PCT Filed: Jan. 14, 2022
(86) PCT No.: PCT/EP2022/050778

§ 371 Date: Jun. 13, 2023

(30) Foreign Application Priority Data
Jan. 14, 2021 (EP) 21382018.6
Sep. 30, 2021 (WO) PCT/CN2021/122070

(51) Int. Cl. H04L 67/1008; H04L 67/51

(52) U.S. Cl. CPC H04L 67/1008; H04L 67/51

(57) ABSTRACT

There is provided a method for prioritising a plurality of first NF nodes of at least one service producer. Transmission of a first message is initiated (202) towards a network repository function (NRF) node. The first message comprises information indicative of a plurality of criteria and an order of importance of the criteria. The information is for use in assigning priority information to the plurality of first NF nodes. For each first NF node, the priority information is indicative of a priority with which the first NF node is to be selected to provide a service relative to at least one other first NF node of the plurality of first NF nodes and the priority information is assigned based on one or more criteria of the criteria that the first NF node meets and the position of the one or more criteria in the order of importance of the criteria.

### TECHNICAL FIELD

The disclosure relates to methods for prioritising a plurality of first network function (NF) nodes of at least one service producer in a network, and nodes configured to operate in accordance with those methods.

### BACKGROUND

There exist various techniques for handling a request for a service in a network. A service request is generally from a consumer of the service (“service consumer”) to a producer of the service (“service producer”). For example, a service request may be from a network function (NF) node of a service consumer to an NF node of a service producer. The NF node of the service consumer and the NF node of the service producer can communicate directly or indirectly. This is referred to as direct communication and indirect communication respectively. In the case of indirect communication, the NF node of the service consumer and the NF node of the service producer may communicate via a service communication proxy (SCP) node.

FIG. 1A-D illustrates different existing systems for handling service requests, as set out in 3GPP TS 23.501 v16.4.0. In more detail, FIGS. 1A and 1B illustrate systems that use direct communication, while FIGS. 1C and 1D illustrate systems that use indirect communication.

In the systems illustrated in FIGS. 1A and 1B, a service request is sent directly from the NF node of the service consumer to the NF node of the service producer. A response to the service request is sent directly from the NF node of the service producer to the NF node of the service consumer. Similarly, any subsequent service requests are sent directly from the NF node of the service consumer to the NF node of the service producer. The system illustrated in FIG. 1B also comprises a network repository function (NRF) node. Thus, in the system illustrated in FIG. 1B, the NF node of the service consumer can query the NRF node to discover suitable NF nodes of the service producer to which to send the service request. In response to such a query, the NF node of the service consumer can receive an NF profile for one or more NF nodes of the service producer and, based on the received NF profile(s) can select an NF node of the service producer to which to send the service request. In the system illustrated in FIG. 1A, the NRF node is not used and instead the NF node of the service consumer may be configured with the NF profile(s) of the NF node(s) of the service producer.

In the systems illustrated in FIGS. 1C and 1D, a service request is sent indirectly from the NF node of the service consumer to the NF node of the service producer via a service communication proxy (SCP) node. A response to the service request is sent indirectly from the NF node of the service producer to the NF node of the service consumer via the SCP node. Similarly, any subsequent service requests are sent indirectly from the NF node of the service consumer to the NF node of the service producer via the SCP node. The systems illustrated in FIGS. 1C and 1D also comprise an NRF node.

In the system illustrated in FIG. 1C, the NF node of the service consumer can query the NRF node to discover suitable NF nodes of the service producer to which to send the service request. In response to such a query, the NF node of the service consumer can receive an NF profile for one or more NF nodes of the service producer and, based on the received NF profile(s) can select an NF node of the service producer to which to send the service request. In this case, the service request sent from the NF node of the service consumer to the SCP node comprises the address of the selected NF node of the service producer. The NF node of the service consumer can forward the service request without performing any further discovery or selection. In case the selected NF node of the service producer is not accessible for any reason, it may be up to the NF node of the service consumer to find an alternative. In other cases, the SCP node may communicate with the NRF node to acquire selection parameters (e.g. location, capacity, etc.) and the SCP node may select an NF node of the service producer to which to send the service request.

In the system illustrated in FIG. 1D, the NF node of the service consumer does not carry out the discovery or selection process. Instead, the NF node of the service consumer adds any necessary discovery and selection parameters (required to find a suitable NF node of the service producer) to the service request that it sends via the SCP node. The SCP node uses the request address and the discovery and selection parameters in the service request to route the service request to a suitable NF node of the service producer. The SCP node can perform discovery with the NRF node.

For the fifth generation core (5GC), from Release 16, the SCP node is included as a network element to allow indirect communication between an NF node of a service consumer and an NF node of a service producer. The indirect communication that is used can be either of the two indirect communications options described earlier with reference to FIGS. 1C and 1D.

Each of the techniques illustrated in FIGS. 1B, 1C and 1D involve a discovery process for discovering NF nodes of a service producer and this involves the NF node of the service consumer receiving an NF profile of one or more NF nodes of the service producer for use in selecting an NF node of the service producer to which to send a service request. The NF node of the service consumer may receive, in a discovery response, one or multiple NF service producer profiles, e.g. of functionally equivalent NF service producer instances. An NF service producer profile can include a priority value that can be used by the NF node of the service consumer to perform selection (or reselection) among the provided NF service producer profiles.

The NF node of the service consumer may define the NF service producer profiles it is interested in by including in the discovery request it transmits to the NRF node some specific query parameters, e.g. target-nf-type, service-names, and/or any other query parameters (such as any one or more of the query parameters defined in clause 6.2.3.2.3.1 in 3GPP 29.510 V17.2.0). The specific query parameters can be those that the NF node of the service consumer requires that corresponding query parameters in the NF service producer profiles, returned in the discovery response from the NRF node, are to match. However, there may be some query parameters that are only a preference of the NF node of the service consumer, rather than a strict requirement.

The NRF node can provide results based on the indicated preferences, as described in the third generation partnership project (3GPP). For example, clause 6.2.3.2.3.1 in 3GPP 29.510 V17.2.0 defines the preferred tracking area identity (“preferred-tai”) as:

| | | | | | |
|---|---|---|---|---|---|
| preferred-tai | Tai | O | 0 . . . 1 | When present, the NRF shall | Query- |
| | | | | prefer NF profiles that can | Params- |
| | | | | serve the TAI, or the NRF | Ext2 |
| | | | | shall return NF profiles not | |
| | | | | matching the TAI if no NF | |
| | | | | profile is found matching | |
| | | | | the TAI. | |

The NRF node needs to include in the discovery response it sends the NF node of the service consumer an indication of whether or not results fulfilling the preferred-tai are provided. For this, a search result attribute is included in the discovery response. For example, clause 6.2.6.2.2 in 3GPP 29.510 V17.2.0 defines the “preferredSearch” as:

| | | | | |
|---|---|---|---|---|
| preferredSearch | Preferred | C | 0 . . . 1 | This information element (IE) |
| | Search | | | shall be present to indicate |
| | | | | whether all the returned NF |
| | | | | profiles match the preferred |
| | | | | query parameters, if the |
| | | | | discovery request contains |
| | | | | any of the query parameters |
| | | | | defined in the PreferredSearch |
| | | | | data type. |

If only one preferred query parameter is included in the discovery request, the NRF node behaves as indicated. For example, if “preferred-tai=TAI-x” is included in the discovery request, then the discovery response may include only NF service producer profiles with the requested TAI-x and “preferredTaiMatchInd=True”. Alternatively, all the results may be included in the discovery response, not taking into account TAI-x, with an indication that “preferredTaiMatchInd=False”.

If more than one preferred query parameter is included in the discovery request, the information provided by the NRF node in the discovery response is insufficient to ease the selection by the NF node of the service consumer. In an example, there may be a first NF node of a service producer (“NFp1”) and a second NF node of a service producer (“NFp2”) with the following attributes provided in their respective profiles:
NFp1: preferred-tai=TAI-x, and preferred-vendor-specific-nf-features=x
NFp2: preferred-tai=TAI-y, and preferred-vendor-specific-nf-features=y

In this example, the discovery request transmitted from the NF node of the service consumer to the NRF node includes the following query parameters:
preferred-tai=TAI-x, and preferred-vendor-specific-nf-features=y.

Then, the NRF node may either provide no results, or provide both NFp1 and NFp2 together with an indication that “preferredTaiMatchInd=False” and an indication that “preferredVendorSpecificFeaturesInd=False”. With this information, the NF node of the service consumer is forced to either perform another NRF discovery with only one preferred query parameter or to check the contents of each of the NF service producer profiles to identify the value of TAI and vendor specific NF features.

Therefore, it is apparent at least from this example that the existing techniques for allowing an NF node of a service consumer to request some preferences for NRF discovery is cumbersome and, in some cases, not useful.

### SUMMARY

It is an object of the disclosure to obviate or eliminate at least some of the above-described disadvantages associated with existing techniques.

In particular, the existing techniques that allow the NF node of the service consumer to request some preferences for the NRF discovery is cumbersome and, in some cases, not useful. Currently, the possibility for the NF node of the service consumer to include multiple query parameters and prioritise among them is not defined. It has thus been realised that an improved technique for prioritising a plurality of NF nodes of at least one service producer is needed.

Therefore, according to an aspect of the disclosure, there is provided a method for prioritising a plurality of first NF nodes of at least one service producer in a network. The method is performed by a network node. The method comprises initiating transmission of a first message towards a network repository function (NRF) node. The first message comprises information indicative of a plurality of criteria and an order of importance of the plurality of criteria. The information is for use in assigning priority information to the plurality of first NF nodes. For each first NF node of the plurality of first NF nodes, the priority information assigned to the first NF node is indicative of a priority with which the first NF node is to be selected to provide a service relative to at least one other first NF node of the plurality of first NF nodes and the priority information is assigned to the first NF node based on one or more criteria of the plurality of criteria that the first NF node meets and the position of the one or more criteria in the order of importance of the plurality of criteria.

According to an aspect of the disclosure, there is provided another method for prioritising a plurality of first NF nodes of at least one service producer in a network. The method is performed by an NRF node. The method comprises receiving a first message from a network node. The first message comprises information indicative of a plurality of criteria and an order of importance of the plurality of criteria. The method comprises assigning priority information to the plurality of first NF nodes. For each first NF node of the plurality of first NF nodes, the priority information assigned to the first NF node is indicative of a priority with which the first NF node is to be selected to provide a service relative to at least one other first NF node of the plurality of first NF nodes and the priority information is assigned to the first NF node based on one or more criteria of the plurality of criteria that the first NF node meets and the position of the one or more criteria in the order of importance of the plurality of criteria.

According to an aspect of the disclosure, there is provided another method for prioritising a plurality of first NF nodes of at least one service producer in a network. The method is performed by an NRF node. The method comprises initiating transmission of a fifth message towards a network node. The fifth message comprises priority information assigned to the plurality of first NF nodes. For each first NF node of the plurality of first NF nodes, the priority information assigned to the first NF node is indicative of a priority with which the first NF node is to be selected to provide a service relative to at least one other first NF node of the plurality of first NF nodes and the priority information is assigned to the first NF node based on one or more criteria of the plurality of criteria that the first NF node meets and the position of the one or more criteria in the order of importance of the plurality of criteria.

According to an aspect of the disclosure, there is provided another method for prioritising a plurality of first NF nodes of at least one service producer in a network. The method is performed by a network node. The method comprises receiving a fifth message from an NRF node. The fifth message comprises priority information assigned to the plurality of first NF nodes. For each first NF node of the plurality of first NF nodes, the priority information assigned to the first NF node is indicative of a priority with which the first NF node is to be selected to provide a service relative to at least one other first NF node of the plurality of first NF nodes and the priority information is assigned to the first NF node based on one or more criteria of the plurality of criteria that the first NF node meets and the position of the one or more criteria in the order of importance of the plurality of criteria.

According to another aspect of the disclosure, there is provided a network node comprising processing circuitry configured to operate in accordance with the method(s) described in respect of the network node. In some embodiments, the network node may comprise at least one memory for storing instructions which, when executed by the processing circuitry, cause the network node to operate in accordance with the method(s) described in respect of the network node.

According to another aspect of the disclosure, there is also provided an NRF node comprising processing circuitry configured to operate in accordance with the method(s) described in respect of the NRF node. In some embodiments, the NRF node may comprise at least one memory for storing instructions which, when executed by the processing circuitry, cause the NRF node to operate in accordance with the method(s) described in respect of the NRF node.

According to another aspect of the disclosure, there is provided a method performed by a system. The method comprises the method(s) described in respect of the NRF node and the method(s) described in respect of the network node.

According to another aspect of the disclosure, there is provided a system comprising at least one NRF node as described earlier and at least one network node as described earlier.

According to another aspect of the disclosure, there is provided a computer program comprising instructions which, when executed by processing circuitry, cause the processing circuitry to perform the method(s) described in respect of the NRF node and/or the method(s) described in respect of the network node.

According to another aspect of the disclosure, there is provided a computer program product, embodied on a non-transitory machine-readable medium, comprising instructions which are executable by processing circuitry to cause the processing circuitry to perform the method(s) described in respect of the NRF node and/or the method(s) described in respect of the network node.

In this way, there is provided a mechanism to enable prioritisation of NF nodes of a service producer (or, for example, the profiles thereof) according to the preferences and corresponding precedence as specified by the NF node of the service consumer. Therefore, an improved technique for prioritising a plurality of first NF nodes of at least one service producer in a network is provided.

### BRIEF DESCRIPTION OF THE DRAWINGS

For a better understanding of the technique, and to show how it may be put into effect, reference will now be made, by way of example, to the accompanying drawings, in which:

FIG. 1A-D is a block diagram illustrating different existing systems;

FIG. 2 is a block diagram illustrating a network node according to an embodiment;

FIG. 3 is a flowchart illustrating a method performed by a network node according to an embodiment;

FIG. 4 is a block diagram illustrating an NRF node according to an embodiment;

FIG. 5 is a flowchart illustrating a method performed by an NRF node according to an embodiment;

FIGS. 6-11 are signalling diagrams illustrating an exchange of signals in a system according to some embodiments;

FIG. 12 is a schematic illustration of a system according to an embodiment;

FIGS. 13-24 are signalling diagrams illustrating an exchange of signals in a system according to some embodiments; and

FIG. 25 is a schematic illustration of a uniform resource identifier structure.

### DETAILED DESCRIPTION

Herein, techniques for handling a discovery request and response in a network are described. A discovery request can also be referred to as a request for discovery. A discovery request is a request for information indicative of one or more network function (NF) nodes of a service producer for providing a service requested by an NF node of a service consumer. Generally, a service is software intended to be managed for users. Herein, a service can be any type of service, such as a communication service (e.g. a notification service or a callback service), a context management (e.g. user equipment context management (UECM)) service, a data management (DM) service, or any other type of service.

Herein, techniques for prioritising a plurality of first NF nodes of at least one service producer in a network are described.

The techniques described herein can be used in respect of any network, such as any communications or telecommunications network, e.g. cellular network. The network may be a fifth generation (5G) network or any other generation network. In some embodiments, the network may be a core network or a radio access network (RAN). The techniques are implemented by a network repository function (NRF) node and a network node. The network node referred to herein may be a second NF node of a service consumer or a first service communication proxy (SCP) node. The first SCP node is a node that is configured to operate as an SCP between the second NF node and the NRF node. Generally, an NRF node is a node that provides NF service registration and discovery. An NRF node thus enables NF nodes to identify services offered by other NF nodes. Further definitions of an NRF node are provided in 3GPP TS 29.510 V16.5.0 and V17.2.0 and the NRF node described herein may be capable of operating in accordance with any of the methods described therein.

An NF is a third generation partnership project (3GPP) adopted, or 3GPP defined, processing function in a network, which has defined functional behaviour and 3GPP defined interfaces. An NF can be implemented either as a network element on a dedicated hardware, as a software instance running on a dedicated hardware, or as a virtualised function instantiated on an appropriate platform, e.g. on a cloud infrastructure. Herein, the term “node” in relation to an “NF node” will be understood to cover each of these scenarios. Herein, references to a plurality of NF nodes of a service producer may refer to, for example, functionally equivalent instances of NF nodes of the service producer.

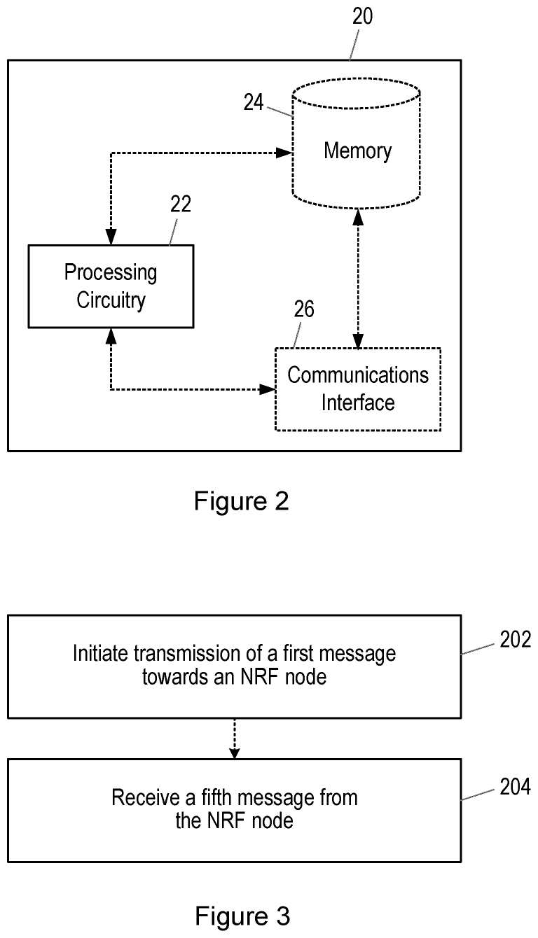

FIG. 2 illustrates a network node 20 in accordance with an embodiment. The network node 20 is for prioritising a plurality of first NF nodes of at least one service producer in a network. The network node can be a second NF node of the service consumer or a first SCP node. The first SCP node is configured to operate as an SCP between the second NF node and an NRF node. In some embodiments, the network node 20 (e.g. the second NF node and/or the first SCP node) can, for example, be a physical machine (e.g. a server) or a virtual machine (VM). The second NF node can be, for example, a user equipment (UE).

As illustrated in FIG. 2, the network node 20 comprises processing circuitry (or logic) 22. The processing circuitry 22 controls the operation of the network node 20 and can implement the method described herein in respect of the network node 20. The processing circuitry 22 can be configured or programmed to control the network node in the manner described herein. The processing circuitry 22 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the network node 20. In some embodiments, the processing circuitry 22 can be configured to run software to perform the method described herein in respect of the network node 20. The software may be containerised according to some embodiments. Thus, in some embodiments, the processing circuitry 22 may be configured to run a container to perform the method described herein in respect of the network node 20.

Briefly, the processing circuitry 22 of the network node 20 is configured to, initiate transmission of a first message towards an NRF node. The first message comprises information indicative of a plurality of criteria and an order of importance of the plurality of criteria. The information is for use in assigning priority information to the plurality of first NF nodes. Alternatively or in addition, the processing circuitry 22 of the network node 20 is configured to receive a fifth message from an NRF node. The fifth message comprises priority information assigned to the plurality of first NF nodes. For each first NF node of the plurality of first NF nodes, the priority information assigned to the first NF node is indicative of a priority with which the first NF node is to be selected to provide a service relative to at least one other first NF node of the plurality of first NF nodes and the priority information is assigned to the first NF node based on one or more criteria of the plurality of criteria that the first NF node meets and the position of the one or more criteria in the order of importance of the plurality of criteria.

As illustrated in FIG. 2, in some embodiments, the network node 20 may optionally comprise a memory 24. The memory 24 of the network node 20 can comprise a volatile memory or a non-volatile memory. In some embodiments, the memory 24 of the network node 20 may comprise a non-transitory media. Examples of the memory 24 of the network node 20 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 22 of the network node 20 can be connected to the memory 24 of the network node 20. In some embodiments, the memory 24 of the network node 20 may be for storing program code or instructions which, when executed by the processing circuitry 22 of the network node 20, cause the network node 20 to operate in the manner described herein in respect of the network node 20. For example, in some embodiments, the memory 24 of the network node 20 may be configured to store program code or instructions that can be executed by the processing circuitry 22 of the network node 20 to cause the network node 20 to operate in accordance with the method described herein in respect of the network node 20. Alternatively or in addition, the memory 24 of the network node 20 can be configured to store any information, data, messages, requests, responses, indications, notifications, signals, or similar, that are described herein. The processing circuitry 22 of the network node 20 may be configured to control the memory 24 of the network node 20 to store information, data, messages, requests, responses, indications, notifications, signals, or similar, that are described herein.

In some embodiments, as illustrated in FIG. 2, the network node 20 may optionally comprise a communications interface 26. The communications interface 26 of the network node 20 can be connected to the processing circuitry 22 of the network node and/or the memory 24 of the network node 20. The communications interface 26 of the network node 20 may be operable to allow the processing circuitry 22 of the network node 20 to communicate with the memory 24 of the network node 20 and/or vice versa. Similarly, the communications interface 26 of the network node 20 may be operable to allow the processing circuitry 22 of the network node 20 to communicate with the NRF node, the first NF node, the second NF node, and/or any other node. The communications interface 26 of the network node 20 can be configured to transmit and/or receive information, data, messages, requests, responses, indications, notifications, signals, or similar, that are described herein. In some embodiments, the processing circuitry 22 of the network node 20 may be configured to control the communications interface 26 of the network node 20 to transmit and/or receive information, data, messages, requests, responses, indications, notifications, signals, or similar, that are described herein.

Although the network node 20 is illustrated in FIG. 2 as comprising a single memory 24, it will be appreciated that the network node 20 may comprise at least one memory (i.e. a single memory or a plurality of memories) 24 that operate in the manner described herein. Similarly, although the network node 20 is illustrated in FIG. 2 as comprising a single communications interface 26, it will be appreciated that the network node 20 may comprise at least one communications interface (i.e. a single communications interface or a plurality of communications interface) 26 that operate in the manner described herein. It will also be appreciated that FIG. 2 only shows the components required to illustrate an embodiment of the network node 20 and, in practical implementations, the network node 20 may comprise additional or alternative components to those shown.

FIG. 3 is a flowchart illustrating a method performed by a network node 20 in accordance with an embodiment. As mentioned earlier, the network node 20 can be the second NF node of a service consumer, or a first SCP node that is configured to operate as an SCP between a second NF node and an NRF node. The method is for prioritising a plurality of first NF nodes of at least one service producer in a network. The network node 20 described earlier with reference to FIG. 2 is configured to operate in accordance with the method of FIG. 3. The method can be performed by or under the control of the processing circuitry 22 of the network node 20.

As illustrated at block 202 of FIG. 3, transmission of a first message is initiated towards an NRF node. Herein, the term “initiate” can mean, for example, cause or establish. Thus, the processing circuitry 22 of the network node 20 can be configured to itself transmit the first message (e.g. via a communications interface 26 of the network node 20) or can be configured to cause another node to transmit the first message. The first message comprises information indicative of a plurality of criteria and an order of importance of the plurality of criteria. The information is for use in assigning priority information to the plurality of first NF nodes. For each first NF node of the plurality of first NF nodes, the priority information assigned to the first NF node is indicative of a priority with which the first NF node is to be selected relative to at least one other first NF node of the plurality of first NF nodes. The first NF node is to be selected to provide (e.g. execute or run) a service. The priority information is assigned to the first NF node based on one or more criteria of the plurality of criteria that the first NF node meets and the position of the one or more criteria in the order of importance of the plurality of criteria.

The priority information referred to herein is for use by the network node 20 in selecting an NF node of a service producer to provide a service requested by a second NF node of a service consumer. The priority information is indicative of a priority with which the first NF node is to be selected relative to at least one other NF node of the service producer. The priority information referred to herein may also be referred to as a priority attribute. In some embodiments, the priority information referred to herein may be a value, such as an integer value. For example, it may be that the lowest value (e.g. 1) is indicative of the highest priority and the highest value (e.g. 65535) is indicative of the lowest priority. This value may also be referred to herein as a priority value.

Herein, a service can be software intended to be managed for users. The service referred to herein can be any type of service, such as a communication service, a context management (e.g. user equipment context management (UECM)) service, a data management (DM) service, or any other type of service.

In some embodiments, the first message may comprise an array and the array may comprise the information indicative of the plurality of criteria and the order of importance of the plurality of criteria. In some of these embodiments, each item of the array may comprise a different criterion of the plurality of criteria and the plurality of criteria are ordered in the array according to their importance.

In some embodiments, the method may comprise initiating transmission of a second message towards the NRF node. The second message can comprise the information indicative of the plurality of criteria and the order of importance of the plurality of criteria and/or information indicative of the plurality of first NF nodes for providing the service and, for each first NF node of the plurality of first NF nodes, the priority information assigned to the first NF node.

In some embodiments, the second message may be a first subscription request, and the first subscription request may be a request for the NRF node to notify the network node 20 of updates to a profile of any first NF nodes of the plurality of first NF nodes or the first subscription request may be a request for the NRF node to notify the network node 20 of updates to the priority information assigned to any first NF nodes of the plurality of first NF nodes. In some embodiments, the first subscription request may be separate from a second subscription request and the second subscription request may be a request for the NRF node to notify the network node 20 of updates to a profile of any first NF nodes of the plurality of first NF nodes.

In some embodiments, the first message may be a discovery request and the discovery request may be a request for information indicative of the plurality of first NF nodes for providing the service.

In other embodiments, the first message may be a subscription request and the subscription request may be a request for the NRF node to notify the network node 20 of updates to a profile of any first NF nodes of the plurality of first NF nodes. The subscription request can be for updates to a profile of one or more (e.g. all) first NF nodes of the plurality of NF nodes. In some embodiments, if the network node stores (or caches) a profile of one or more of the plurality of first NF nodes provided in a discovery response, then the network node 20 may subscribe to changes in the profile of those first NF node(s). An existing subscription can involve, for example, one (e.g. instance of a) first NF node or a set of first NF nodes (e.g. or a set of instances of a first NF node). In some embodiments, the priority information may not be provided in the subscription request. For example, instead, the NRF node may determine the priority information and optionally also store it, e.g. as part of other information stored for the subscription. This allows the NRF node to send, to the network node, a notification of updates to a profile of one or more of the first NF nodes of the plurality of first NF nodes only when the priority information has changed.

In other embodiments, the first message may be a first subscription request and the first subscription request may be a request for the NRF node to notify the network node of updates to the priority information assigned to any first NF nodes of the plurality of first NF nodes. In some embodiments, the first subscription request may comprise information indicative of the plurality of first NF nodes for providing the service. In some embodiments, the first subscription request may be separate from a second subscription request and the second subscription request may be a request for the NRF node to notify the network node 20 of updates to a profile of any first NF nodes of the plurality of first NF nodes.

In other embodiments, the first message may comprise an identifier and the identifier may be the information indicative of the plurality of criteria and the order of importance of the plurality of criteria. In some embodiments, the information indicative of the plurality of criteria and the order of importance of the plurality of criteria may be an identity of a resource of the NRF node at which the information indicative of the plurality of criteria and the order of importance of the plurality of criteria is stored. In some embodiments, the method may comprise receiving a third message comprising the identifier from the NRF node. In some embodiments, the third message may be a discovery response and the discovery response may comprise information indicative of the plurality of first NF nodes for providing the service and information indicative that the priority information has been assigned to the plurality of first NF nodes. In some embodiments, the identifier may be a uniform resource identifier (URI). The identifier (e.g. URI) referred to herein can be used to access the information indicative of the plurality of criteria and the order of importance of the plurality of criteria.

In some embodiments, the method may comprise initiating transmission of a discovery request towards the NRF node. The discovery request can be a request for information indicative of the plurality of first NF nodes for providing the service and the discovery request may comprise information indicative that the network node 20 is to be subscribed to updates to the priority information assigned to any first NF nodes of the plurality of first NF nodes.

In some embodiments, the method may comprise initiating transmission of a (new) discovery request towards the NRF node in response to receiving a fourth message from the NRF node. The fourth message may comprise information indicative that the network node 20 is to initiate transmission of a (new) discovery request towards the NRF node. The (new) discovery request can be a request for information indicative of an alternative plurality of first NF nodes for providing the service and may comprise the information indicative of the plurality of criteria and the order of importance of the plurality of criteria. The (new) discovery request can be similar to an earlier discovery request. Thus, it may start the earlier described process again.

Returning back to FIG. 3, alternatively or in addition to initiating transmission of the first message, as illustrated at block 204 of FIG. 3, a fifth message is received from an NRF node. The fifth message comprises priority information assigned to the plurality of first NF nodes. For each first NF node of the plurality of first NF nodes, the priority information assigned to the first NF node is indicative of a priority with which the first NF node is to be selected relative to at least one other first NF node of the plurality of first NF nodes. The first NF node is to be selected to provide (e.g. execute or run) a service. The priority information is assigned to the first NF node based on one or more criteria of the plurality of criteria that the first NF node meets and the position of the one or more criteria in the order of importance of the plurality of criteria.

In some embodiments, the method may comprise selecting a first NF node from the plurality of first NF nodes to provide the service, where the first NF node can be selected based on the priority information. In some embodiments, the priority information assigned to the selected first NF node may be indicative that a priority with which the selected first NF node is to be selected is higher than a priority with which the other first NF nodes are to be selected. As mentioned before, the priority information is indicative of a priority with which the first NF nodes are to be selected relative to each other. Thus, for example, a first NF node that has the highest priority (e.g. indicated by the lower priority value of “1”) may be selected. The NRF node can thus prioritise the first NF nodes by assignment of priority information (e.g. a priority value) to each of the first NF nodes. In this way, the first NF nodes can be ordered (or ranked). If multiple first NF nodes are assigned the same priority information, a first NF node may be randomly selected from the first NF nodes for which the priority information indicates a highest priority for selection. In some embodiments, the selection may be based on one or more other criteria as well as the priority information.

The one or more other criteria referred to herein may, for example, be any one or more of a location of each first NF node, a load on each first NF node, a capacity of each first NF node and/or any other criterion, or any combination of criteria. In some embodiments, it may be configured in the NRF node (e.g. by an operator) that the priority information is to take precedence over all other criteria, e.g. including any other criteria provided in the discovery request. In other embodiments, it may be configured in the NRF node (e.g. by an operator) that the priority information is to take precedence over all other criteria, e.g. including any other criteria provided in the discovery request, except for one or more criteria (e.g. except for locality). In other embodiments, the NRF node may be configured to perform health supervision and identify whether any one or more first NF nodes (e.g. regardless of any criteria) are down such that those one or more first NF nodes can be deprioritised.

In some embodiments, the fifth message may be a discovery response. The discovery response may comprise information indicative of the plurality of first NF nodes for providing the service and information indicative that the priority information has been assigned to the plurality of first NF nodes.

In other embodiments, the fifth message may be a subscription response and the subscription response may comprise information indicative of an update to a profile of one or more first NF nodes of the plurality of first NF nodes.

In other embodiments, the fifth message may be a first subscription response and the first subscription response may comprise information indicative of an update to the priority information assigned to one or more first NF nodes of the plurality of first NF nodes. In some embodiments, the first subscription response may be separate from a second subscription response and the second subscription response may comprise information indicative of an update to a profile of one or more first NF nodes of the plurality of first NF nodes.

In some embodiments, the method may comprise receiving a fourth message from the NRF node. The fourth message may comprise information indicative that the network node 20 is to initiate transmission of a (new) discovery request towards the NRF node. The (new) discovery request can be a request for information indicative of an alternative plurality of first NF nodes for providing the service. The (new) discovery request can be similar to an earlier discovery request. Thus, it may start the earlier described process again.

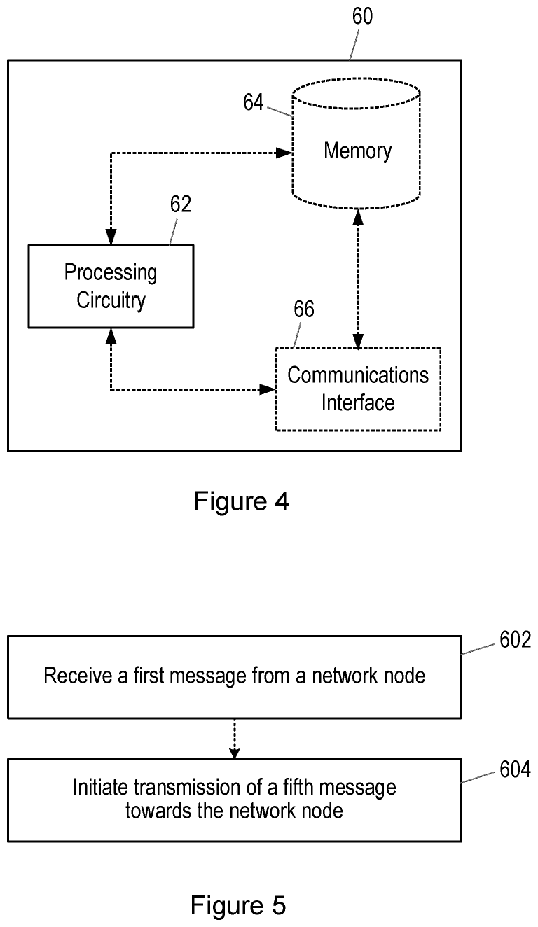

FIG. 4 illustrates a network repository function (NRF) node 60 in accordance with an embodiment. The NRF node 60 is for prioritising a plurality of first NF nodes of at least one service producer in a network. In some embodiments, the NRF node 60 can, for example, be a physical machine (e.g. a server) or a virtual machine (VM).

As illustrated in FIG. 4, the NRF node 60 comprises processing circuitry (or logic) 62. The processing circuitry 62 controls the operation of the NRF node 60 and can implement the method described herein in respect of the NRF node 60. The processing circuitry 62 can be configured or programmed to control the NRF node 60 in the manner described herein. The processing circuitry 62 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the NRF node 60. In some embodiments, the processing circuitry 62 can be configured to run software to perform the method described herein in respect of the NRF node 60. The software may be containerised according to some embodiments. Thus, in some embodiments, the processing circuitry 62 may be configured to run a container to perform the method described herein in respect of the NRF node 60.

Briefly, the processing circuitry 62 of the NRF node 60 is configured to receive a first message from a network node 20. The first message comprises information indicative of a plurality of criteria and an order of importance of the plurality of criteria. The processing circuitry 62 of the NRF node 60 is configured to assign priority information to the plurality of first NF nodes. Alternatively or in addition, the processing circuitry 62 of the NRF node 60 is configured to initiate transmission of a fifth message towards a network node 20. The fifth message comprises priority information assigned to the plurality of first NF nodes. For each first NF node of the plurality of first NF nodes, the priority information assigned to the first NF node is indicative of a priority with which the first NF node is to be selected relative to at least one other first NF node of the plurality of first NF nodes. The first NF node is to be selected to provide (e.g. execute or run) a service. The priority information is assigned to the first NF node based on one or more criteria of the plurality of criteria that the first NF node meets and the position of the one or more criteria in the order of importance of the plurality of criteria.

As illustrated in FIG. 4, in some embodiments, the NRF node 60 may optionally comprise a memory 64. The memory 64 of the NRF node 60 can comprise a volatile memory or a non-volatile memory. In some embodiments, the memory 64 of the NRF node 60 may comprise a non-transitory media. Examples of the memory 64 of the NRF node 60 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 62 of the NRF node 60 can be connected to the memory 64 of the NRF node 60. In some embodiments, the memory 64 of the NRF node 60 may be for storing program code or instructions which, when executed by the processing circuitry 62 of the NRF node 60, cause the NRF node 60 to operate in the manner described herein in respect of the NRF node 60. For example, in some embodiments, the memory 64 of the NRF node 60 may be configured to store program code or instructions that can be executed by the processing circuitry 62 of the NRF node 60 to cause the NRF node 60 to operate in accordance with the method described herein in respect of the NRF node 60. Alternatively or in addition, the memory 64 of the NRF node 60 can be configured to store any information, data, messages, requests, responses, indications, notifications, signals, or similar, that are described herein. The processing circuitry 62 of the NRF node 60 may be configured to control the memory 64 of the NRF node 60 to store information, data, messages, requests, responses, indications, notifications, signals, or similar, that are described herein.

In some embodiments, as illustrated in FIG. 4, the NRF node 60 may optionally comprise a communications interface 66. The communications interface 66 of the NRF node 60 can be connected to the processing circuitry 62 of the NRF node 60 and/or the memory 64 of the NRF node 60. The communications interface 66 of the NRF node 60 may be operable to allow the processing circuitry 62 of the NRF node 60 to communicate with the memory 64 of the NRF node 60 and/or vice versa. Similarly, the communications interface 66 of the NRF node 60 may be operable to allow the processing circuitry 62 of the NRF node 60 to communicate with the first NF node, the network node (e.g. the second NF node and/or first SCP node) 20, and/or any other node. The communications interface 66 of the NRF node 60 can be configured to transmit and/or receive information, data, messages, requests, responses, indications, notifications, signals, or similar, that are described herein. In some embodiments, the processing circuitry 62 of the NRF node 60 may be configured to control the communications interface 66 of the NRF node 60 to transmit and/or receive information, data, messages, requests, responses, indications, notifications, signals, or similar, that are described herein.

Although the NRF node 60 is illustrated in FIG. 4 as comprising a single memory 64, it will be appreciated that the NRF node 60 may comprise at least one memory (i.e. a single memory or a plurality of memories) 64 that operate in the manner described herein. Similarly, although the NRF node 60 is illustrated in FIG. 4 as comprising a single communications interface 66, it will be appreciated that the NRF node 60 may comprise at least one communications interface (i.e. a single communications interface or a plurality of communications interface) 66 that operate in the manner described herein. It will also be appreciated that FIG. 4 only shows the components required to illustrate an embodiment of the NRF node 60 and, in practical implementations, the NRF node 60 may comprise additional or alternative components to those shown.

FIG. 5 is a flowchart illustrating a method performed by an NRF node 60 in accordance with an embodiment. The method is for handling an updated profile of a first NF node of a service producer in a network. The NRF node 60 described earlier with reference to FIG. 4 is configured to operate in accordance with the method of FIG. 5. The method can be performed by or under the control of the processing circuitry 62 of the NRF node 60.

As illustrated at block 602 of FIG. 5, a first message is received from a network node and priority information is assigned to the plurality of first NF nodes. The first message comprises information indicative of a plurality of criteria and an order of importance of the plurality of criteria. For each first NF node of the plurality of first NF nodes, the priority information assigned to the first NF node is indicative of a priority with which the first NF node is to be selected relative to at least one other first NF node of the plurality of first NF nodes. The first NF node is to be selected to provide (e.g. execute or run) a service. The priority information is assigned to the first NF node based on one or more criteria of the plurality of criteria that the first NF node meets and the position of the one or more criteria in the order of importance of the plurality of criteria. The priority information can be assigned to the plurality of first NF nodes based on the plurality of criteria and the order of importance of the plurality of criteria. For example, if a first NF node meets the most important criteria of the plurality of criteria, this first NF node may be assigned priority information that indicates that it is to be selected with a higher priority than another first NF node that does not meet the most important criteria.

In some embodiments, the first message may comprise an array and the array may comprise the information indicative of the plurality of criteria and the order of importance of the plurality of criteria. In some of these embodiments, each item of the array may comprise a different criterion of the plurality of criteria and the plurality of criteria are ordered in the array according to their importance.

In some embodiments, the method may comprise receiving a second message from the network node 20. The second message may comprise the information indicative of the plurality of criteria and the order of importance of the plurality of criteria and/or information indicative of the plurality of first NF nodes for providing the service and, for each first NF node of the plurality of first NF nodes, the priority information assigned to the first NF node.

In some embodiments, the second message may be a first subscription request, and the first subscription request may be a request for the NRF node 60 to notify the network node 20 of updates to a profile of any first NF nodes of the plurality of first NF nodes or the first subscription request may be a request for the NRF node 60 to notify the network node 20 of updates to the priority information assigned to any first NF nodes of the plurality of first NF nodes. In some embodiments, the first subscription request may be separate from a second subscription request and the second subscription request may be a request for the NRF node 60 to notify the network node of updates to a profile of any first NF nodes of the plurality of first NF nodes.

In some embodiments, the first message may be a discovery request and the discovery request can be a request for information indicative of the plurality of first NF nodes for providing the service.

In other embodiments, the first message may be a subscription request and the subscription request may be a request for the NRF node 60 to notify the network node 20 of updates to a profile of any first NF nodes of the plurality of first NF nodes.

In other embodiments, the first message may be a first subscription request and the first subscription request may be a request for the NRF node 60 to notify the network node 20 of updates to the priority information assigned to any first NF nodes of the plurality of first NF nodes. In some embodiments, the first subscription request may comprise information indicative of the plurality of first NF nodes for providing the service. In some embodiments, the first subscription request may be separate from a second subscription request and the second subscription request may be a request for the NRF node 60 to notify the network node 20 of updates to a profile of any first NF nodes of the plurality of first NF nodes.

In some embodiments, the method may comprise storing any or more of the priority information, the information indicative of the plurality of criteria and the order of importance of the plurality of criteria, and information indicative of the plurality of first NF nodes for providing the service.

In other embodiments, the first message may comprise an identifier and the identifier may be the information indicative of the plurality of criteria and the order of importance of the plurality of criteria. In some embodiments, the identifier may be a uniform resource identifier (URI). In some embodiments, the information indicative of the plurality of criteria and the order of importance of the plurality of criteria may be an identity of a resource of the NRF node 60 at which the information indicative of the plurality of criteria and the order of importance of the plurality of criteria is stored.

In some embodiments, the method may comprise initiating transmission of a third message comprising the identifier towards the network node 20. In some embodiments, the third message may be a discovery response and the discovery response may comprise information indicative of the plurality of first NF nodes for providing the service and information indicative that the priority information has been assigned to the plurality of first NF nodes.

In some embodiments, the method may comprise receiving a discovery request from the network node 20, where the discovery request can be a request for information indicative of the plurality of first NF nodes for providing the service and the discovery request may comprise information indicative that the network node 20 is to be subscribed to updates to the priority information assigned to any first NF nodes of the plurality of first NF nodes.

In some embodiments, the method may comprise storing, in a memory of the NRF node 60, any one or more of the information indicative of the plurality of first NF nodes for providing the service and the information indicative of the plurality of criteria and the order of importance of the plurality of criteria.

In some embodiments, assigning the priority information to the plurality of first NF nodes may comprise modifying priority information previously assigned to the plurality of first NF nodes. In some embodiments, the priority information may be assigned in response to an update to a profile of one or more first NF nodes of the plurality of first NF nodes or in response to another trigger.

In some embodiments, the update to the profile may comprise any one or more of an update to one or more attributes in the profile, wherein the assigned priority information is based on the one or more attributes and an update to priority information in the profile, wherein the assigned priority information is based on the priority information in the profile.

In some embodiments, the method may comprise receiving a (new) discovery request from the network node 20. The (new) discovery request can be a request for information indicative of an alternative plurality of first NF nodes for providing the service and may comprise the information indicative of the plurality of criteria and the order of importance of the plurality of criteria. The (new) discovery request can be similar to an earlier discovery request. Thus, it may start the earlier described process again.

Returning back to FIG. 5, alternatively or in addition to receiving the first message, as illustrated at block 604 of FIG. 5, transmission of a fifth message is initiated towards a network node 20. Herein, the term “initiate” can mean, for example, cause or establish. Thus, the processing circuitry 62 of the NRF node 60 can be configured to itself transmit the fifth message (e.g. via a communications interface 66 of the NRF node 60) or can be configured to cause another node to transmit the fifth message. The fifth message comprises priority information assigned to the plurality of first NF nodes. For each first NF node of the plurality of first NF nodes, the priority information assigned to the first NF node is indicative of a priority with which the first NF node is to be selected relative to at least one other first NF node of the plurality of first NF nodes. The first NF node is to be selected to provide (e.g. execute or run) a service. The priority information is assigned to the first NF node based on one or more criteria of the plurality of criteria that the first NF node meets and the position of the one or more criteria in the order of importance of the plurality of criteria.

In some embodiments, the fifth message may be a discovery response and the discovery response may comprise information indicative of the plurality of first NF nodes for providing the service and information indicative that the priority information has been assigned to the plurality of first NF nodes.

In other embodiments, the fifth message may be a subscription response and the subscription response may comprise information indicative of an update to a profile of one or more first NF nodes of the plurality of first NF nodes.

In other embodiments, the fifth message may be a first subscription response and the first subscription response may comprise information indicative of an update to the priority information assigned to one or more first NF nodes of the plurality of first NF nodes. In some embodiments, the first subscription response may be separate from a second subscription response and the second subscription response may comprise information indicative of an update to a profile of one or more first NF nodes of the plurality of first NF nodes.

In some embodiments, the method may comprise initiating transmission of a fourth message towards the network node 20. The fourth message can comprise information indicative that the network node 20 is to initiate transmission of a (new) discovery request towards the NRF node 60. The (new) discovery request can be a request for information indicative of an alternative plurality of first NF nodes for providing the service. The (new) discovery request can be similar to an earlier discovery request. Thus, it may start the earlier described process again.

In some embodiments, the plurality of criteria referred to herein may comprise any one or more of a criterion indicative that first NF nodes located at a predefined location are preferred (e.g. “preferred-locality” as defined in Table 6.2.3.2.3.1-1 of 3GPP TS 29.510 V17.2.0), a criterion indicative that first NF nodes serving a predefined tracking area identity (TAI) are preferred (e.g. “preferred-tai” as defined in Table 6.2.3.2.3.1-1 of 3GPP TS 29.510 V17.2.0), a criterion indicative that a predefined instance of first NF nodes are preferred (e.g. “preferred-nf-instances” as defined in Table 6.2.3.2.3.1-1 of 3GPP TS 29.510 V17.2.0), a criterion indicative that first NF nodes supporting a predefined application programming interface (API) version of the service are preferred (e.g. “preferred-api-versions” as defined in Table 6.2.3.2.3.1-1 of 3GPP TS 29.510 V17.2.0), a criterion indicative that first NF nodes serving a full public land mobile network (PLMN) are preferred (e.g. “preferred-full-plmn” as defined in Table 6.2.3.2.3.1-1 of 3GPP TS 29.510 V17.2.0), a criterion indicative that first NF nodes supporting one or more predefined vendor specific features for the service are preferred (e.g. “preferred-vendor-specific-features” as defined in Table 6.2.3.2.3.1-1 of 3GPP TS 29.510 V17.2.0), and a criterion indicative that first NF nodes supporting one or more predefined vendor specific features for the first NF nodes are preferred (e.g. “preferred-vendor-specific-nf-features” as defined in Table 6.2.3.2.3.1-1 of 3GPP TS 29.510 V17.2.0). The plurality of criteria referred to herein may comprise any one or more of a criterion that are preferred by the first NF node, rather than a strict requirement. The plurality of criteria may also be referred to herein as a plurality of (preferred) parameters or a plurality of (preferred) query parameters.

In some embodiments, if multiple preferred parameters are included in a discovery request from the network node 20 to the NRF node 60, the network node 20 may still search into a profile of one or more first NF nodes of the plurality of first NF nodes to select (or reselect) a first NF node from the plurality of first NF nodes to provide the service. In some embodiments, any NF service producer profile updates in the network node 20 may consider the same priority information (e.g. “altered priority”) as that returned in the discovery response. In some embodiments, it may be controlled how a change to the priority information for one or more first NF nodes may impact the priority information for other first NF nodes. In some embodiments, a session management function, SMF, node (or any other network node) may use the priority information, such as to identify an active first NF node compared to a first NF node that is in standby. In this situation, it may be that the priority information is not changed by the NRF node 60.

In the manner described herein, a new query parameter is defined that allows the network node 20 to indicate the precedence order among preferred query parameters (when the first message includes more than one preference query parameter for the expected results from the NRF node 60). Based on that, and optionally also other (e.g. internal) criteria, the NRF node 60 can provide results with changed priority information in order to accommodate the preferences of the network node 20 as well as the precedence among them.

In some embodiments, once the discovery results are provided, if the network node 20 may subscribe to get notifications when first NF node profiles are updated, the subscription request from the network node 20 to the NRF node 60 may include the preferences and corresponding precedence in order to allow the NRF node 60 to update the priority information accordingly. Alternatively, an identifier that identifies the previous discovery results (“search Id”) may be included in this subscription request. This identifier can be returned to the network node 20 from the NRF node 60 in a previous discovery response.

In some embodiments, the procedure to change the priority information may take into account that, if a first NF node profile is modified at any time after discovery, then the priority information to be provided (e.g. in the first NF node profile) is to be changed by the NRF node 60 with the same criteria that was considered when all the discovery results are provided. This can ensure consistency among all the returned first NF node profiles. The procedure to modify the priority information used in discovery results can allow the priority information of an individual first NF node profile to be updated without having to update the rest of the first NF node profiles (provided in the same discovery result). In some embodiments, if any criteria that requires modification of the priority information for a first NF node is altered (e.g. as a result of a first NF node attribute that impacts the priority information determination by the NRF node 60, or a configurable event in the NRF node 60), the NRF node 60 may redetermine the affected priority information for the first NF node and optionally also send a notification with the updated priority information (and optionally any other updated attribute, if applicable) to the network node 20. If the modification does not affect the priority information, then it may be that the priority information is not included in the notification and thus the existing priority information at the network node 20 may be kept.

There may be three different variants of the method that can be employed, alone or in combination, according to some embodiments. In a first variant (“Variant A”), an indication that the NRF node 60 has changed priority information may be provided in the discovery response from the NRF node 60 to the network node 20. Instead of including new information in an existing subscription, a new subscription to be notified of a change to priority information may be defined, as well as its corresponding notification. In a second variant (“Variant B”), an identifier (e.g. URI) may be provided in the discovery response from the NRF node 60 to the network node 20. This identifier can allow the network node 20 to subscribe to changes in priority information.

It can thus be highlighted that the NRF node 60 has changed priority information (similar to Variant A). Instead of including new information in an existing subscription, a new subscription to be notified of a change to priority information may be defined (to the provided identifier), as well as its corresponding notification. In a third variant (“Variant C”), a new indication that may be included in the discovery response from the NRF node 60 to the network node 20 to indicate that a new discovery request is required. The indication may, for example, indicate that a reorder of first NF nodes is required.

With regard to Variant A and B, an indication of whether the NRF node 60 has changed the priority information can be provided in the discovery results. This has the advantage that the network node 20 may consider whether the results should be cached (e.g. for a limited amount of time) and it allows the network node 20 to have more control over the first NF node selection (or reselection) process. For example, the network node 20 may decide to check locality anyway, or other parameters, when the priority information is not modified, or even when it is modified. With regard to Variant B, there is no need to include the preferences and their precedence used in the discovery request in the subscription request. This helps to decrease overlapping between discovery and NF management services in the NRF node 60. With regard to Variant C, the need for the NRF node 60 to employ a procedure that allows the priority information of one first NF node to be altered independently of the rest of the first NF nodes is avoided. This can support a use case in which an event or modification of attributes in first NF node profile(s) requires a change to previously altered priority information.

The proposed techniques described herein allow the NRF node 60 to change priority information. That is, they allow the NRF node 60 to implement an “altering priority feature”. According to some of the proposed techniques described herein, the network node 20 may acquire results from a discovery that are already ordered according to its preferences. In this way, the network node 20 then simply needs to select (or reselect in the case that there has already been a previous selection) a first NF node based on the priority information. This is a simplification for the network node 20 as it avoids the need for the network node 20 to take into account multiple criteria for the selection (or reselection), after parsing first NF node profile contents. The NRF node 60 can be a centralised element that takes care of providing results following the preferences and requirements of the network node 20. In this way, the implementation of that logic is centralised in a single node, while the network node 20 only needs to use the priority information for the selection (or reselection) among provided results. The notifications of modified first NF node profiles may be subject to the same network node 20 preferences and requirements. In this way, the network node 20 can always have a consistent view for the selection among first NF nodes.

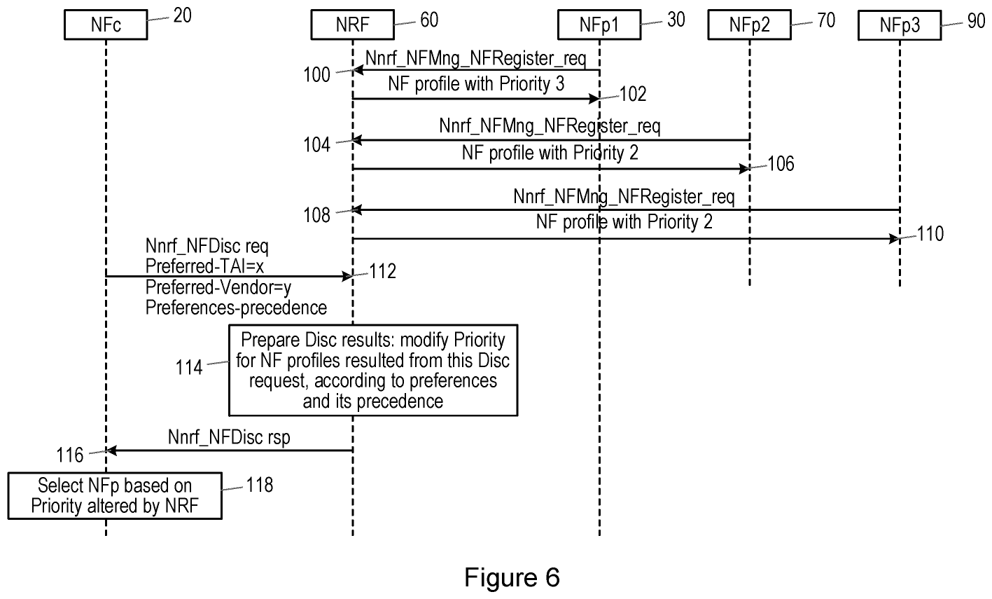

There is also provided a method performed by a system. The method comprises the method(s) described herein in respect of the network node 20 and the method(s) described herein in respect of the NRF node 60. There is also provided a system comprising at least one network node 20 as described herein and at least one NRF node 60 as described herein. Some example systems that employ the techniques described herein will now be described with reference to the signalling diagrams of FIGS. 6-11. As will become apparent from this description with reference to FIGS. 6-11, there are various issues with existing techniques that can be addressed using the techniques described herein.

A first issue (“Issue i”) is that, if multiple preferred parameters are included in the discovery request, the network node still needs to search into the first NF node profiles in order to select (or reselect) a first NF node to provide a service according to existing the techniques. This first issue can be addressed by the inclusion of network node preferences and their precedence in the discovery request, as illustrated in FIG. 6.

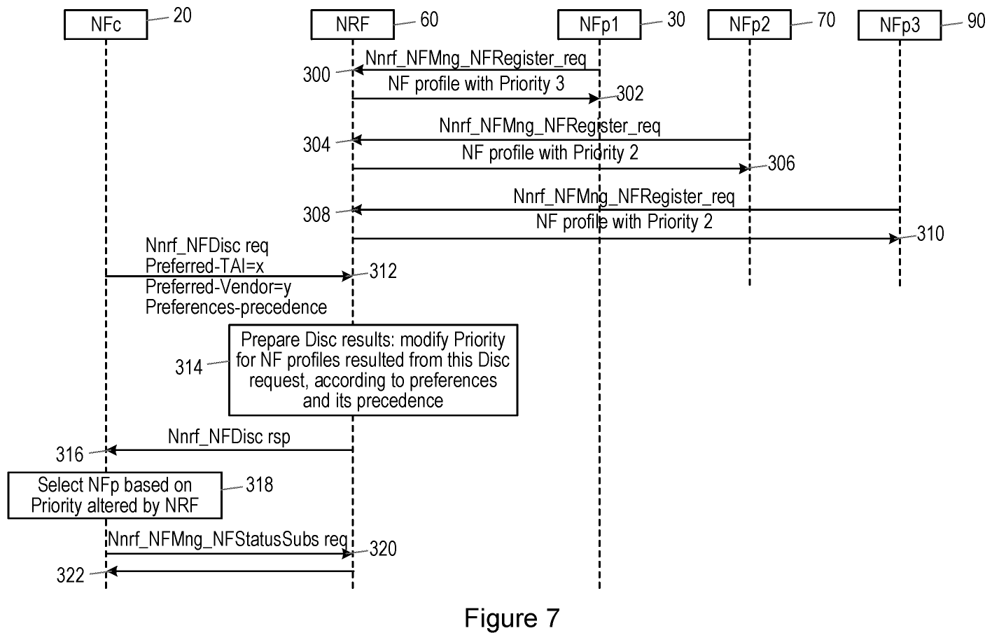

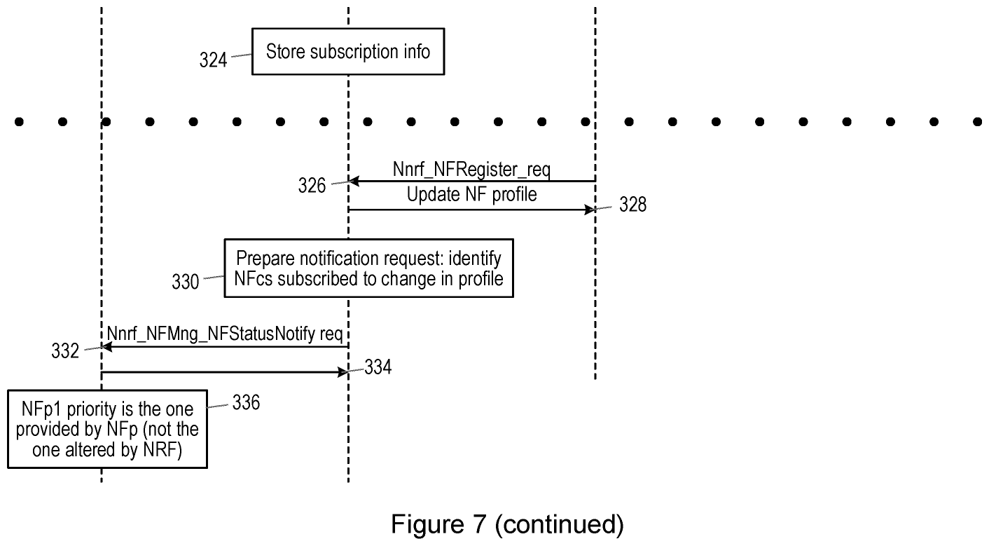

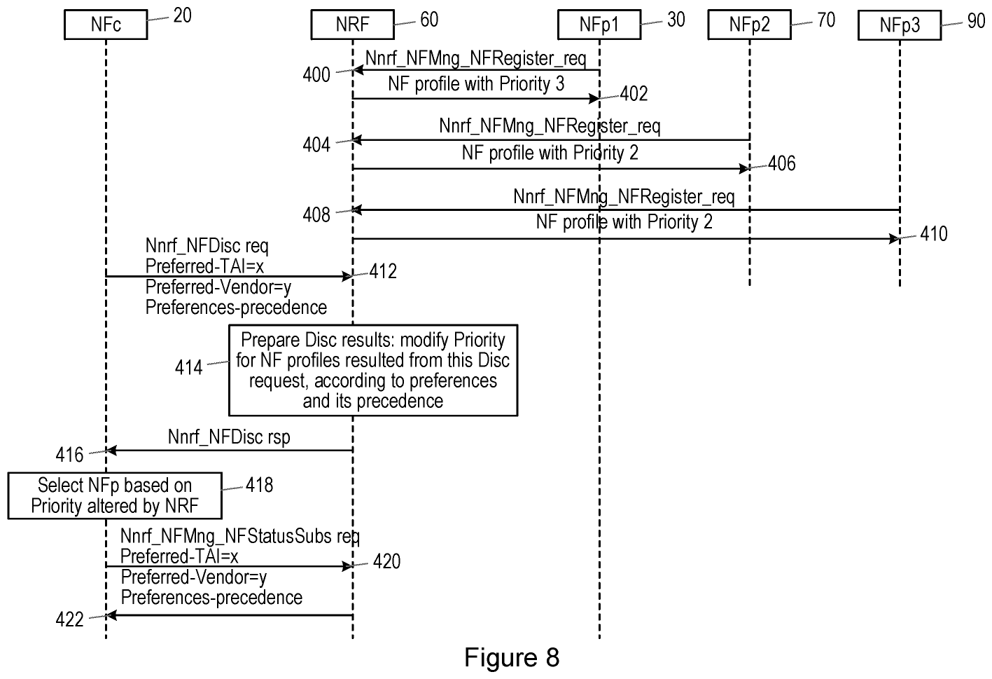

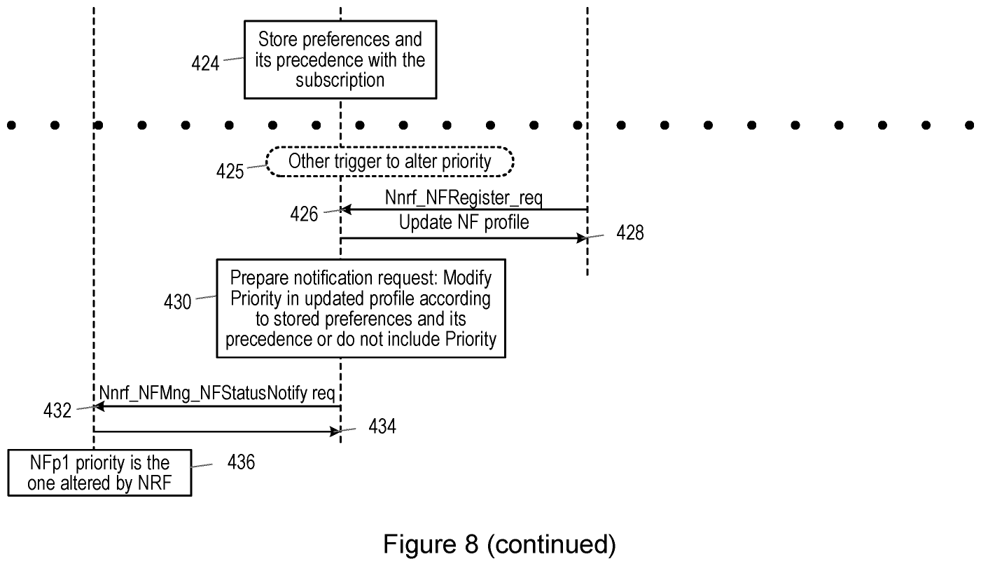

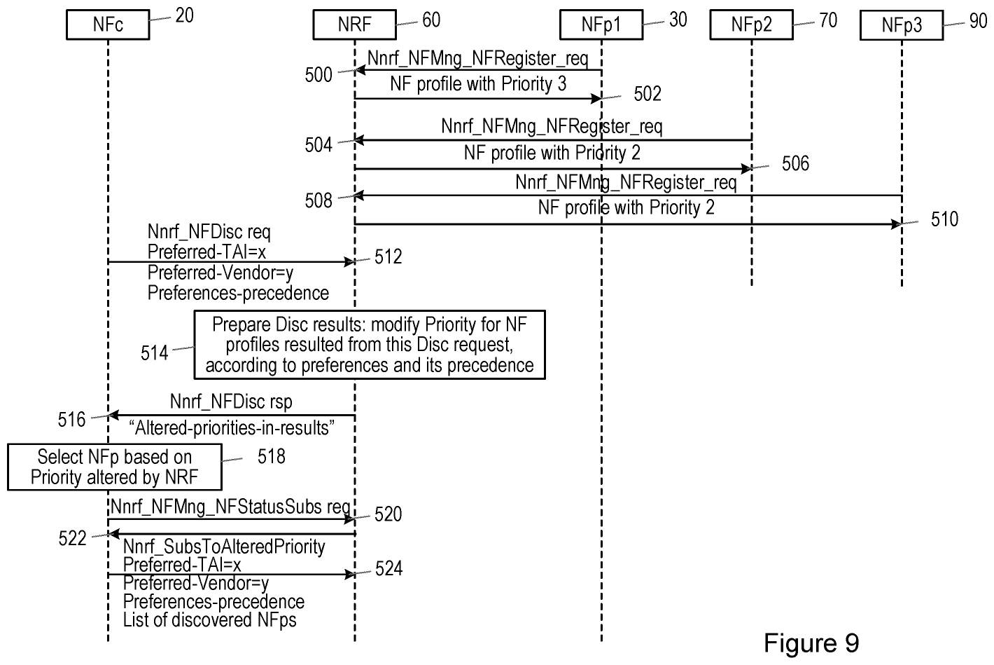

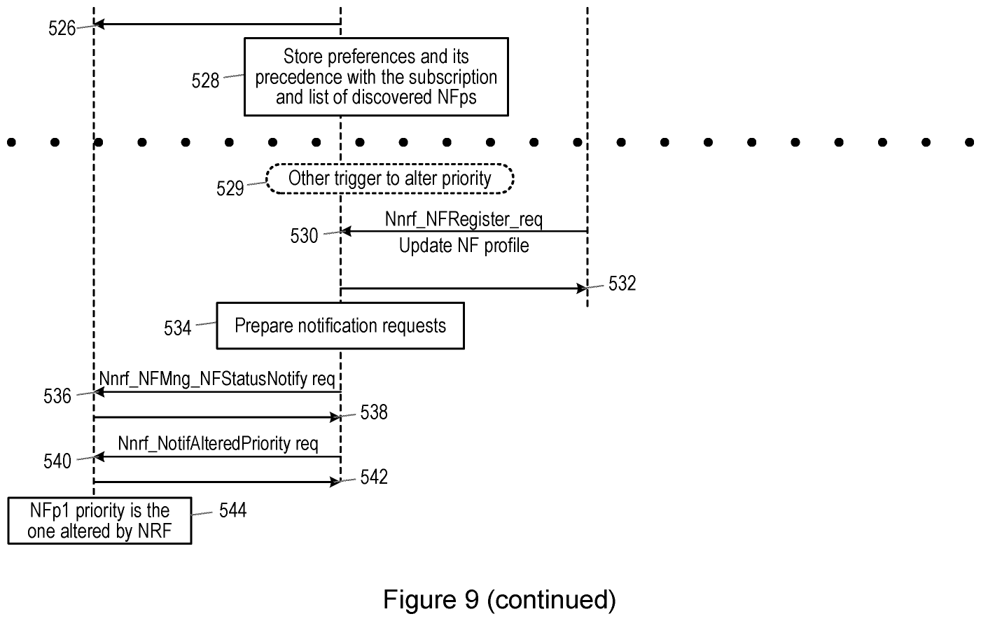

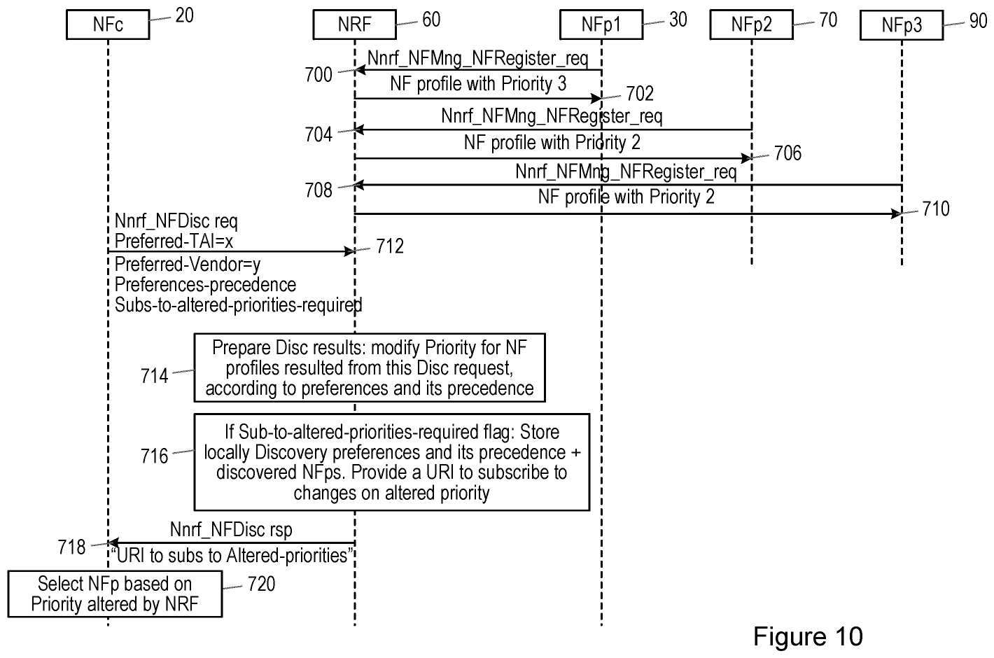

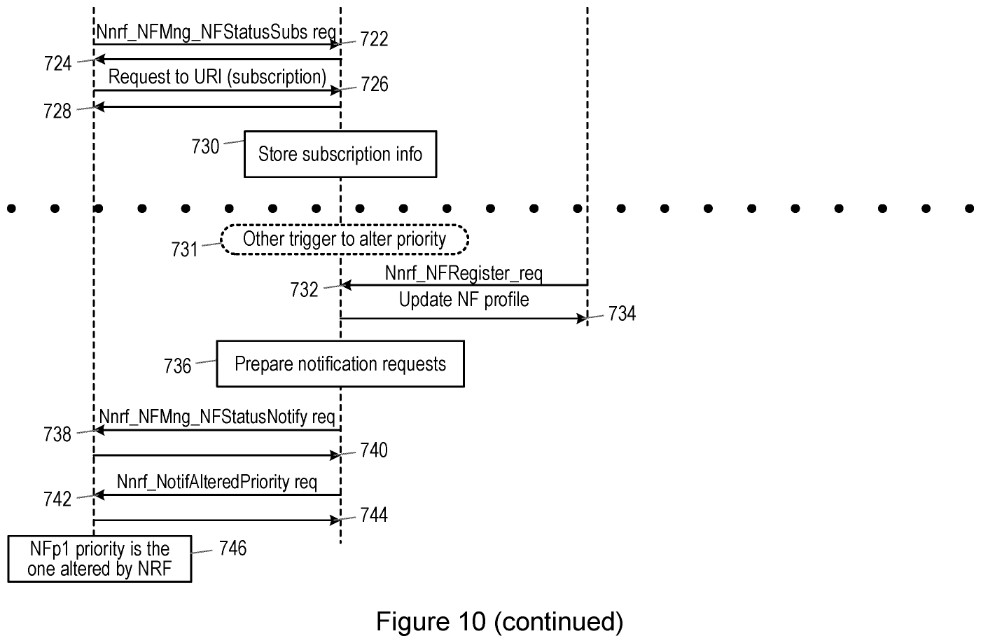

A second issue (“Issue ii”), which is illustrated in FIG. 7, is that the network node 20 considers the subsequently modified priority information in the first NF profile, rather than the priority information originally modified by the NRF node 60 and provided in the discovery response according to the existing techniques. This second issue can be addressed by the inclusion of network node preferences and their precedence in an existing subscription request, as illustrated in FIG. 8. This second issue can alternatively be addressed by the inclusion of network node preferences and their precedence in a new subscription request, as illustrated in FIG. 9. This second issue can alternatively be addressed by storing network node preferences and their precedence in the NRF node 60 and providing an identifier (e.g. URI) to subscribe to that, as illustrated in FIG. 10.

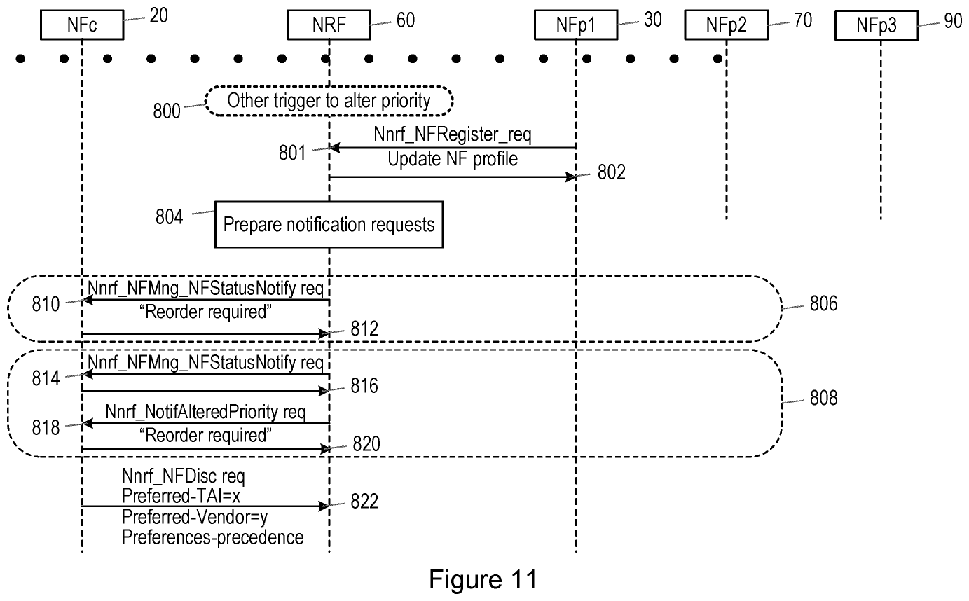

A third issue (“Issue iii”) is that there is no control over how modification of the priority of one first NF node profile may impact the altered priority information for other first NF nodes in the existing techniques. This third issue can be addressed by the inclusion of network node preferences and their precedence in a new subscription request, as illustrated in FIG. 9. This third issue can alternatively be addressed by an indication that a new discovery is needed, as illustrated in FIG. 11. This third issue can alternatively be addressed by way of an altered-priority algorithm in the NRF node 60 that determines the priority information for each first NF node independently of others first NF nodes.

FIG. 6 is a signalling diagram illustrating an exchange of signals in a system according to an embodiment. The system illustrated in FIG. 6 comprises a network node 20 and an NRF node 60. The system illustrated in FIG. 6 may optionally also comprise a plurality of first NF nodes 30, 70, 90 of a service producer (“NFp1”, “NFp2”, “NFp3”). Although three first NF nodes 30, 70, 90 are illustrated, the system illustrated in FIG. 6 can comprise one or more first NF nodes. The plurality of first NF nodes 30, 70, 90 can each be configured to provide a service. The first NF nodes 30, 70, 90 can be part of a set of NF service producer nodes according to some embodiments.

As illustrated in FIG. 6, the network node 20 can be a second NF node of a service consumer (“NFc”) according to some embodiments. However, in other embodiments (not illustrated), the network node 20 can be a first SCP node. Thus, the method described herein with respect to the second NF node 20 may instead be performed by the first SCP node. In these embodiments, the first SCP node is configured to operate as an SCP between second NF node 20 and the NRF node 60. Similarly, a second SCP node may be configured to operate as an SCP between the NRF node 60 and any one or more of the first NF nodes 30, 70, 90.

In some embodiments where the system comprises the first SCP node, an entity may comprise the first SCP node and the NRF node 60. That is, in some embodiments, the first SCP node can be merged with the NRF node 60 in a combined entity. In some embodiments where the system comprises the second SCP node, an entity may comprise the second SCP node and the NRF node 60. That is, in some embodiments, the second SCP node can be merged with the NRF node 60 in a combined entity. The system illustrated in FIG. 6 can comprise one or more SCP nodes according to some embodiments.

In some embodiments, the first SCP node and the second NF node 20 may be deployed in independent deployment units, and/or the first SCP node and the NRF node 60 may be deployed in independent deployment units. Thus, an SCP node based on independent deployment units is possible, as described in 3GPP TS 23.501 V16.4.0. In other embodiments, the first SCP node may be deployed as a distributed network element. For example, in some embodiments, part (e.g. a service agent) of the first SCP node may be deployed in the same deployment unit as the second NF node 20, and/or part (e.g. a service agent) of the first SCP node may be deployed in the same deployment unit as the NRF node 60. Thus, an SCP node based on a service mesh is possible, as described in 3GPP TS 23.501 V16.4.0.

In some embodiments, the second SCP node and any one or more of the first NF nodes 30, 70, 90 may be deployed in independent deployment units, and/or the second SCP node and the NRF node 60 may be deployed in independent deployment units. Thus, an SCP node based on independent deployment units is possible, as described in 3GPP TS 23.501 V16.4.0. In other embodiments, the second SCP node may be deployed as a distributed network element. For example, in some embodiments, part (e.g. a service agent) of the second SCP node may be deployed in the same deployment unit as any one or more of the first NF nodes 30, 70, 90 and/or part (e.g. a service agent) of the second SCP node may be deployed in the same deployment unit as the NRF node 60. Thus, an SCP node based on a service mesh is possible, as described in 3GPP TS 23.501 V16.4.0.

In some embodiments, at least one third SCP node may be configured to operate as an SCP between the second NF node 20 and the first SCP node, and/or at least one fourth SCP node may be configured to operate as an SCP between the first SCP node and the NRF node 60. Similarly, in some embodiments, at least one fifth SCP node may be configured to operate as an SCP between the NRF node 60 and the second SCP node, and/or at least one sixth SCP node may be configured to operate as an SCP between the second SCP node and any one or more of the first NF nodes 30, 70, 90. Thus, a multipath of SCP nodes is possible. In some of these embodiments, the first SCP node and one or more of the at least one third SCP node and the at least one fourth SCP node may be deployed in independent deployment units. In some embodiments, the at least one third SCP node and/or the at least one fourth SCP node may be deployed as distributed network elements. In some embodiments, the second SCP node and one or more of the at least one fifth SCP node and the at least one sixth SCP node may be deployed in independent deployment units. In some embodiments, the at least one fifth SCP node and/or the at least one sixth SCP node may be deployed as distributed network elements.

With reference to FIG. 6, registration of a plurality of first NF nodes 30, 70, 90 in the NRF node 60 is performed, with certain priority information, as determined by the respective first NF nodes of the plurality of first NF nodes 30, 70, 90. In more detail, as illustrated by arrows 100, 104, and 108 of FIG. 6, each first NF node of the plurality of NF nodes 30, 70, 90 initiates transmission of a register request (“Nnrf_NFMng_NFRegister_req”) towards the NRF node 60. The register requests 100, 104, 108 may be transmitted directly from the respective first NF nodes 30, 70, 90 to the NRF node 60 (as illustrated in FIG. 6) or indirectly from respective first NF nodes 30, 70, 90 to the NRF node 60, e.g. via the second SCP node. The NRF node 60 receives the register requests 100, 104, 108. Each register request 100, 104, 108 is a request for the NRF node 60 to register the respective first NF node 30, 70, 90. For example, each register request 100, 104, 108 can be a request for the NRF node 60 to register the respective first NF node 30, 70, 90 as an NF node of a service producer that is capable of providing a service.

As illustrated in FIG. 6, each register request 100, 104, 108 can comprise a profile of the respective first NF node 30, 70, 90. The profile of each first NF node 30, 70, 90 can comprise priority information for the respective first NF node 30. In the embodiment illustrated in FIG. 6, the priority information for the first NF node 30 is a priority value of “3”, the priority information for the first NF node 70 is a priority value of “2”, and the priority information for the first NF node 90 is a priority value of “2”. The priority information is for use by the network node (e.g. second NF node) 20 in selecting an NF node of a service producer to provide a service requested by the second NF node. The priority information is indicative of a priority with which the first NF node 30 is to be selected relative to at least one other first NF node 70, 90. As illustrated by arrows 102, 106, 110, the NRF node 60 transmits a response to each register request 100, 104, 108 towards the respective first NF node 30, 70, 90.

For the purpose of the embodiment illustrated in FIG. 6, the following data is considered to be present in the first NF profiles:
NFp1: taiList or taiRangeList includes TAI-x, and supported-features includes “y”;
NFp2: taiList or taiRangeList includes TAI-x, and supported-features includes “x”; and
NFp3: taiList or taiRangeList includes TAI-y, and supported-features includes “y”.

As illustrated by arrow 112 of FIG. 6, the second NF node 20 transmits a message towards the NRF node 60 (e.g. directly or indirectly such as via the first SCP node) and the NRF node 60 receives the message. This message is referred to herein as the “first message”. In the embodiment illustrated in FIG. 6, the first message 112 is a discovery request, which is a request for information indicative of the plurality of first NF nodes 30, 70, 90 for providing a service requested by the second NF node 20. The first message 112 comprises information indicative of a plurality of criteria and an order of importance of the plurality of criteria. The information is for use in assigning priority information to the plurality of first NF nodes 30, 70, 90. This information may comprise a new query parameter, which may be referred to as “preferences-precedence”. In the embodiment illustrated in FIG. 6, the plurality of criteria comprises “preferred-tai=TAI-x” and “preferred-vendor-specific-nf-features=y” and the order of importance of the plurality of criteria is “preferred-tai, preferred-vendor-specific-nf-features”. The first criterion in the list takes precedence over the second criterion in the list (and, similarly, the second criterion in the list takes precedence over the third criterion in the list, the third criterion in the list take precedence over the fourth criterion in the list, and so on). Thus, the order of importance provided indicates that “preferred-tai=TAI-x” takes precedence over “preferred-vendor-specific-nf-features”.

As illustrated by block 114 of FIG. 6, the NRF node 60 prepares discovery results derived from the discovery request 112. More specifically, the NRF node 60 assigns (e.g. modified) priority information to the plurality of first NF nodes 30, 70, 90. The plurality of first NF nodes 30, 70, 90 can be analysed according to the plurality of criteria and their order of importance (i.e. the preferences and their precedence) in order to assign (e.g. modified) priority information accordingly. The method to assign (e.g. modified) priority information may allow that, if one single first NF profile is updated, then the NRF node 60 knows which priority information (according to the preferences and their precedence) is to be set. In some embodiments, some other criteria aside from those indicated as query parameters may be used as well.

As illustrated by arrow 116 of FIG. 6, the NRF node 60 transmits a message towards the second NF node 20 (e.g. directly or indirectly such as via the first SCP node) and the second NF node 20 receives the message. This message is referred to herein as the “fifth message”. The fifth message 116 comprises priority information assigned to the plurality of first NF nodes 30, 70, 90. For example, the respective NF profiles of the plurality of first NF nodes 30, 70, 90 comprising the priority information assigned by the NRF node 60 may be returned. For each first NF node 30 of the plurality of first NF nodes 30, 70, 90, the priority information assigned to the first NF node 30 is indicative of a priority with which the first NF node 30 is to be selected to provide a service relative to at least one other first NF node 70, 90 of the plurality of first NF nodes 30, 70, 90 and the priority information is assigned to the first NF node 30 based on one or more criteria of the plurality of criteria that the first NF node 30 meets and the position of the one or more criteria in the order of importance of the plurality of criteria.

As illustrated by block 118 of FIG. 6, the second NF node 20 selects a first NF node from the plurality of first NF nodes 30, 70, 90 to provide the service. This selection is based on the priority information assigned by the NRF node 60, e.g. based only on this priority information or based on this priority information in addition to one or more other criteria. In the embodiment illustrated in FIG. 6, the first NF node 30 that has the highest priority is selected. The first NF node 30 has the highest priority since it has the “preferred-tai=TAI-x”, which is the most important criteria to meet, and it also has the “preferred-vendor-specific-nf-features=y”, which is the next most important criteria to meet. On the other hand, the first NF node 70 also has the “preferred-tai=TAI-x” but does not have the “preferred-vendor-specific-nf-features=y” and the first NF node 90 has the “preferred-vendor-specific-nf-features=y” but not the more important “preferred-tai=TAI-x”. The selection of a first NF node 30 is improved due to the advantageous manner in which the priority information is assigned by the NRF node 60.

FIG. 7 is a signalling diagram illustrating an exchange of signals according to an embodiment. The system illustrated in FIG. 7 comprises a network node 20 and an NRF node 60. The system illustrated in FIG. 7 may optionally also comprise a plurality of first NF nodes 30, 70, 90 of a service producer (“NFp1”, “NFp2”, “NFp3”). Although three first NF nodes 30, 70, 90 are illustrated, the system illustrated in FIG. 7 can comprise one or more first NF nodes. The plurality of first NF nodes 30, 70, 90 can each be configured to provide a service. The first NF nodes 30, 70, 90 can be part of a set of NF service producer nodes according to some embodiments.

As illustrated in FIG. 7, the network node 20 can be a second NF node of a service consumer (“NFc”) according to some embodiments. However, in other embodiments (not illustrated), the network node 20 can be a first SCP node. Thus, the method described herein with respect to the second NF node 20 may instead be performed by the first SCP node. In these embodiments, the first SCP node is configured to operate as an SCP between second NF node 20 and the NRF node 60. Similarly, a second SCP node may be configured to operate as an SCP between the NRF node 60 and any one or more of the first NF nodes 30, 70, 90.

In some embodiments where the system comprises the first SCP node, an entity may comprise the first SCP node and the NRF node 60. That is, in some embodiments, the first SCP node can be merged with the NRF node 60 in a combined entity. In some embodiments where the system comprises the second SCP node, an entity may comprise the second SCP node and the NRF node 60. That is, in some embodiments, the second SCP node can be merged with the NRF node 60 in a combined entity. The system illustrated in FIG. 7 can comprise one or more SCP nodes according to some embodiments.

In some embodiments, the first SCP node and the second NF node 20 may be deployed in independent deployment units, and/or the first SCP node and the NRF node 60 may be deployed in independent deployment units. Thus, an SCP node based on independent deployment units is possible, as described in 3GPP TS 23.501 V16.4.0. In other embodiments, the first SCP node may be deployed as a distributed network element. For example, in some embodiments, part (e.g. a service agent) of the first SCP node may be deployed in the same deployment unit as the second NF node 20, and/or part (e.g. a service agent) of the first SCP node may be deployed in the same deployment unit as the NRF node 60. Thus, an SCP node based on a service mesh is possible, as described in 3GPP TS 23.501 V16.4.0.

In some embodiments, the second SCP node and any one or more of the first NF nodes 30, 70, 90 may be deployed in independent deployment units, and/or the second SCP node and the NRF node 60 may be deployed in independent deployment units. Thus, an SCP node based on independent deployment units is possible, as described in 3GPP TS 23.501 V16.4.0. In other embodiments, the second SCP node may be deployed as a distributed network element. For example, in some embodiments, part (e.g. a service agent) of the second SCP node may be deployed in the same deployment unit as any one or more of the first NF nodes 30, 70, 90 and/or part (e.g. a service agent) of the second SCP node may be deployed in the same deployment unit as the NRF node 60. Thus, an SCP node based on a service mesh is possible, as described in 3GPP TS 23.501 V16.4.0.

In some embodiments, at least one third SCP node may be configured to operate as an SCP between the second NF node 20 and the first SCP node, and/or at least one fourth SCP node may be configured to operate as an SCP between the first SCP node and the NRF node 60. Similarly, in some embodiments, at least one fifth SCP node may be configured to operate as an SCP between the NRF node 60 and the second SCP node, and/or at least one sixth SCP node may be configured to operate as an SCP between the second SCP node and any one or more of the first NF nodes 30, 70, 90. Thus, a multipath of SCP nodes is possible. In some of these embodiments, the first SCP node and one or more of the at least one third SCP node and the at least one fourth SCP node may be deployed in independent deployment units. In some embodiments, the at least one third SCP node and/or the at least one fourth SCP node may be deployed as distributed network elements. In some embodiments, the second SCP node and one or more of the at least one fifth SCP node and the at least one sixth SCP node may be deployed in independent deployment units. In some embodiments, the at least one fifth SCP node and/or the at least one sixth SCP node may be deployed as distributed network elements.

At steps 300 to 318 of FIG. 7, the method described earlier with respect to steps 100 to 118 of FIG. 6 respectively is performed.

As illustrated by arrow 320 of FIG. 7, the second NF node 20 transmits a subscription request towards the NRF node 60 (e.g. directly or indirectly such as via the first SCP node) and the NRF node 60 receives the subscription request. The subscription request 320 is a request for the NRF node 60 to notify the second NF node 20 of updates to a profile of any first NF nodes 30 of the plurality of first NF nodes 30, 70, 90. As illustrated by arrow 322 of FIG. 7, the NRF node 60 transmits a response to the subscription request towards the second NF node 20 (e.g. directly or indirectly such as via the first SCP node) and the second NF node 20 receives the response. As illustrated at block 324 of FIG. 7, the NRF node 60 stores subscription information.

There is an update to a profile of a first NF node 30, e.g. an update to an attribute in the profile. As illustrated by arrow 326 of FIG. 7, the first NF node 30 transmits a registration request towards the NRF node 60 and the NRF node 60 receives the registration request 326. The registration request 326 comprises the updated profile for the first NF node 30 and requests that it is registered. The first NF node 30 provides priority information in the profile. As illustrated by arrow 328 of FIG. 7, the NRF node 60 transmits a response to the registration request 326 towards the first NF node 30 and the first NF node 30 receives the response 328.

As illustrated by block 330 of FIG. 7, the NRF node 60 prepares a notification request and identifies any second NF node subscribed to updates to a profile of any first NF nodes 30 of the plurality of first NF nodes 30, 70, 90. As illustrated by arrow 332 of FIG. 7, the NRF node 60 transmits the notification request towards the second NF node 20 (e.g. directly or indirectly such as via the first SCP node) and the second NF node 20 receives the notification request. As illustrated by arrow 334 of FIG. 7, the second NF node 20 transmits a response to the notification request towards the NRF node 60 (e.g. directly or indirectly such as via the first SCP node) and the NRF node 60 receives the response. The notification request comprises the updated profile of the first NF node 30 with the priority information provided by the first NF node 30.

Thus, as illustrated by block 336 of FIG. 7, if the first NF node 30 modifies any attribute in its profile and the second NF node is subscribed to receive notification of any profile modification, the second NF node receives the priority information provided by the first NF node 30 and not the (modified) priority information assigned by the NRF node 60 at block 314 of FIG. 7. As such, the priority information assigned by the NRF node 60 is lost and the selection based on this priority information is spoilt. Therefore, although the initial selection of a first NF node at block 318 is improved by the inclusion of the new information in the discovery request 312, the method may be further improved for any subsequent first NF node selection.

FIG. 8 is a signalling diagram illustrating an exchange of signals in a system according to an embodiment. The system illustrated in FIG. 8 comprises a network node 20 and an NRF node 60. The system illustrated in FIG. 8 may optionally also comprise a plurality of first NF nodes 30, 70, 90 of a service producer (“NFp1”, “NFp2”, “NFp3”). Although three first NF nodes 30, 70, 90 are illustrated, the system illustrated in FIG. 8 can comprise one or more first NF nodes. The plurality of first NF nodes 30, 70, 90 can each be configured to provide a service. The first NF nodes 30, 70, 90 can be part of a set of NF service producer nodes according to some embodiments.

As illustrated in FIG. 8, the network node 20 can be a second NF node of a service consumer (“NFc”) according to some embodiments. However, in other embodiments (not illustrated), the network node 20 can be a first SCP node. Thus, the method described herein with respect to the second NF node 20 may instead be performed by the first SCP node. In these embodiments, the first SCP node is configured to operate as an SCP between the second NF node 20 and the NRF node 60. Similarly, a second SCP node may be configured to operate as an SCP between the NRF node 60 and any one or more of the first NF nodes 30, 70, 90.

In some embodiments where the system comprises the first SCP node, an entity may comprise the first SCP node and the NRF node 60. That is, in some embodiments, the first SCP node can be merged with the NRF node 60 in a combined entity. In some embodiments where the system comprises the second SCP node, an entity may comprise the second SCP node and the NRF node 60. That is, in some embodiments, the second SCP node can be merged with the NRF node 60 in a combined entity. The system illustrated in FIG. 8 can comprise one or more SCP nodes according to some embodiments.

In some embodiments, the first SCP node and the second NF node 20 may be deployed in independent deployment units, and/or the first SCP node and the NRF node 60 may be deployed in independent deployment units. Thus, an SCP node based on independent deployment units is possible, as described in 3GPP TS 23.501 V16.4.0. In other embodiments, the first SCP node may be deployed as a distributed network element. For example, in some embodiments, part (e.g. a service agent) of the first SCP node may be deployed in the same deployment unit as the second NF node 20, and/or part (e.g. a service agent) of the first SCP node may be deployed in the same deployment unit as the NRF node 60. Thus, an SCP node based on a service mesh is possible, as described in 3GPP TS 23.501 V16.4.0.

In some embodiments, the second SCP node and any one or more of the first NF nodes 30, 70, 90 may be deployed in independent deployment units, and/or the second SCP node and the NRF node 60 may be deployed in independent deployment units. Thus, an SCP node based on independent deployment units is possible, as described in 3GPP TS 23.501 V16.4.0. In other embodiments, the second SCP node may be deployed as a distributed network element. For example, in some embodiments, part (e.g. a service agent) of the second SCP node may be deployed in the same deployment unit as any one or more of the first NF nodes 30, 70, 90 and/or part (e.g. a service agent) of the second SCP node may be deployed in the same deployment unit as the NRF node 60. Thus, an SCP node based on a service mesh is possible, as described in 3GPP TS 23.501 V16.4.0.

In some embodiments, at least one third SCP node may be configured to operate as an SCP between the second NF node 20 and the first SCP node, and/or at least one fourth SCP node may be configured to operate as an SCP between the first SCP node and the NRF node 60. Similarly, in some embodiments, at least one fifth SCP node may be configured to operate as an SCP between the NRF node 60 and the second SCP node, and/or at least one sixth SCP node may be configured to operate as an SCP between the second SCP node and any one or more of the first NF nodes 30, 70, 90. Thus, a multipath of SCP nodes is possible. In some of these embodiments, the first SCP node and one or more of the at least one third SCP node and the at least one fourth SCP node may be deployed in independent deployment units. In some embodiments, the at least one third SCP node and/or the at least one fourth SCP node may be deployed as distributed network elements. In some embodiments, the second SCP node and one or more of the at least one fifth SCP node and the at least one sixth SCP node may be deployed in independent deployment units. In some embodiments, the at least one fifth SCP node and/or the at least one sixth SCP node may be deployed as distributed network elements.

At steps 400 to 418 of FIG. 8, the method described earlier with respect to steps 100 to 118 of FIG. 6 respectively is performed.

As illustrated by arrow 420 of FIG. 8, the second NF node 20 transmits a message towards the NRF node 60 (e.g. directly or indirectly such as via the first SCP node) and the NRF node 60 receives the message. This message 420 is referred to herein as the “second message”. The second message 420 comprises the information indicative of the plurality of criteria and the order of importance of the plurality of criteria. This is a new query parameter, which may be referred to as “preferences-precedence”. In the embodiment illustrated in FIG. 8, the plurality of criteria comprises “preferred-tai=TAI-x” and “preferred-vendor-specific-nf-features=y” and the order of importance of the plurality of criteria is “preferred-tai, preferred-vendor-specific-nf-features”. The first criterion in the list takes precedence over the second criterion in the list (and, similarly, the second criterion in the list takes precedence over the third criterion in the list, the third criterion in the list take precedence over the fourth criterion in the list, and so on). Thus, the order of importance provided indicates that “preferred-tai=TAI-x” takes precedence over “preferred-vendor-specific-nf-features”.

The second message 420 is a (existing) subscription request, which is a request for the NRF node 60 to notify the second NF node 20 of updates to a profile of any first NF nodes 30 of the plurality of first NF nodes 30, 70, 90. The subscription request thus includes the same preferences and their precedence as in the discovery request 412. Alternatively, an identifier that identifies the previous discovery results (“search Id”) may be included in the subscription request. This identifier can be returned to the second NF node 20 from the NRF node 60 in a previous discovery response. In some embodiments, this step may be executed prior to step 412 of FIG. 4. As illustrated by arrow 422 of FIG. 8, the NRF node 60 transmits a response to the subscription request towards the second NF node 20 (e.g. directly or indirectly such as via the first SCP node) and the second NF node 20 receives the response. Thus, the second NF node 20 subscribes to be notified if profile(s) of the first NF node(s) 30, 70, 90 are modified. As illustrated at block 424 of FIG. 8, the NRF node 60 stores the information indicative of the plurality of criteria and the order of importance of the plurality of criteria, and optionally also any other subscription information. This storage can allow the second NF node 20 to subscribe to using this stored information.

There may be a reason for the NRF node 60 to trigger a redetermination of the priority information of a first NF node 30. For example, the former provided altered priority information may be overwritten by an update of the first NF node profile. In this case, the NRF node 60 may either remove the priority information from the updated profile so that the second NF node 20 knows the former one is valid or the NRF node 60 may redetermine the priority information and provide it again to the second NF node 20. In another example, the former provided altered priority information may need to be modified. This can, for example, occur when any parameter (e.g. priority itself, load, capacity, etc.) in the first NF node profile that is used for determination of priority information is modified. This can also occur when there are other criteria (e.g. configurable in the NRF node 60) that affect the priority information, e.g. a health status of the first NF node that is supervised by the NRF node 60. In this case, the NRF node 60 may need to provide new priority information to the second NF node 20.

In the embodiment illustrated in FIG. 8, as illustrated by block 425, there may be a trigger other than an update to a profile of a first NF node 30 that requires that the NRF node 60 provides altered priority information for the first NF node 30. For example, a health supervision of the first NF node 30 may be indicate that this is required. Alternatively, there may be an update to a profile of a first NF node 30 that means that the priority information of a first NF node 30 needs to be altered. For example, it can be a change to the priority information in the profile or a change to another attribute (e.g. load, capacity, allowed NF types, etc.) in the profile that the NRF node 60 previously used to determine the priority information for the first NF node 30. In this case, as illustrated by arrow 426 of FIG. 8, the first NF node 30 transmits a registration request towards the NRF node 60 and the NRF node 60 receives the registration request 426. The registration request 426 comprises the updated profile for the first NF node 30 and requests that it is registered. The first NF node 30 provides priority information in the profile similar to its first registration (e.g. a priority value of “3”). As illustrated by arrow 428 of FIG. 8, the NRF node 60 transmits a response to the registration request 426 towards the first NF node 30 and the first NF node 30 receives the response 428.

As illustrated by block 430 of FIG. 8, the NRF node 60 assigns priority information to the first NF node 30 according to the stored information indicative of the plurality of criteria and the order of importance of the plurality of criteria. This can result in the priority information in the updated profile received from the first NF node 30 being modified. The NRF node 60 prepares a notification request and identifies any second NF node subscribed to updates to a profile of any first NF nodes 30 of the plurality of first NF nodes 30, 70, 90. If the priority information itself, or other parameters that are used by the NRF node 60 to determine priority information (e.g. load, capacity, etc.) are modified, then the NRF node 60 needs to redetermine the previously altered priority information and include that in the notification request. The NRF node 60 updates the priority information according to stored preferences and their precedence and optionally any extra criteria (similarly as for the discovery result 112). It may be that the same criteria are used to obtain the priority information as the criteria that is used at step 414 of FIG. 8. In an example, if the parameter “AllowedNFtypes” is modified but this does not require modification of the first NF node order for selection (or reselection), then the priority information does not need to be changed. In this case, the NRF node 60 may either not include the priority information in the notification request (so that the second NF node 20 knows the former priority information is valid) or the same priority information may be included in the notification request.

As illustrated by arrow 432 of FIG. 8, the NRF node 60 transmits the notification request towards the second NF node 20 (e.g. directly or indirectly such as via the first SCP node) and the second NF node 20 receives the notification request 432. This notification request 432 is referred to herein as the “fifth message”. As illustrated by arrow 434 of FIG. 8, the second NF node 20 transmits a response to the notification request 432 towards the NRF node 60 (e.g. directly or indirectly such as via the first SCP node) and the NRF node 60 receives the response. The notification request 432 comprises the updated profile of the first NF node 30 with the priority information assigned by the NRF node 60 at block 430.

Thus, as illustrated by block 436 of FIG. 8, even if the first NF node 30 modifies any attribute in its profile and the second NF node is subscribed to receive notification of any profile modification, the second NF node receives the priority information assigned by the NRF node 60 at block 430 of FIG. 8. The priority information received for the first NF node 30 at step 416 of FIG. 8 (as assigned by the NRF node 60) can be overwritten by the priority information received for the first NF node 30 at step 432 of FIG. 8 (as also assigned by the NRF node 60). Alternatively, where there is no priority information included in the notification request 432, the former priority information that the second NF node 20 received at step 416 of FIG. 8 (as assigned by the NRF node 60) remains valid.

The selection of a first NF node based on the priority information is therefore improved due to the advantageous manner in which this priority information is assigned by the NRF node 60. If the modified attribute in the profile of the first NF node 30 does not impact the determination of the priority information, then the NRF node 60 may not include priority information in the updated profile, which can be interpreted by the as the second NF node 20 that the priority information has not changed.

FIG. 9 is a signalling diagram illustrating an exchange of signals in a system according to an embodiment. The system illustrated in FIG. 9 comprises a network node 20 and an NRF node 60. The system illustrated in FIG. 9 may optionally also comprise a plurality of first NF nodes 30, 70, 90 of a service producer (“NFp1”, “NFp2”, “NFp3”). Although three first NF nodes 30, 70, 90 are illustrated, the system illustrated in FIG. 9 can comprise one or more first NF nodes. The plurality of first NF nodes 30, 70, 90 can each be configured to provide a service. The first NF nodes 30, 70, 90 can be part of a set of NF service producer nodes according to some embodiments.

As illustrated in FIG. 9, the network node 20 can be a second NF node of a service consumer (“NFc”) according to some embodiments. However, in other embodiments (not illustrated), the network node 20 can be a first SCP node. Thus, the method described herein with respect to the second NF node 20 may instead be performed by the first SCP node. In these embodiments, the first SCP node is configured to operate as an SCP between second NF node 20 and the NRF node 60. Similarly, a second SCP node may be configured to operate as an SCP between the NRF node 60 and any one or more of the first NF nodes 30, 70, 90.

In some embodiments where the system comprises the first SCP node, an entity may comprise the first SCP node and the NRF node 60. That is, in some embodiments, the first SCP node can be merged with the NRF node 60 in a combined entity. In some embodiments where the system comprises the second SCP node, an entity may comprise the second SCP node and the NRF node 60. That is, in some embodiments, the second SCP node can be merged with the NRF node 60 in a combined entity. The system illustrated in FIG. 9 can comprise one or more SCP nodes according to some embodiments.

In some embodiments, the first SCP node and the second NF node 20 may be deployed in independent deployment units, and/or the first SCP node and the NRF node 60 may be deployed in independent deployment units. Thus, an SCP node based on independent deployment units is possible, as described in 3GPP TS 23.501 V16.4.0. In other embodiments, the first SCP node may be deployed as a distributed network element. For example, in some embodiments, part (e.g. a service agent) of the first SCP node may be deployed in the same deployment unit as the second NF node 20, and/or part (e.g. a service agent) of the first SCP node may be deployed in the same deployment unit as the NRF node 60. Thus, an SCP node based on a service mesh is possible, as described in 3GPP TS 23.501 V16.4.0.

In some embodiments, the second SCP node and any one or more of the first NF nodes 30, 70, 90 may be deployed in independent deployment units, and/or the second SCP node and the NRF node 60 may be deployed in independent deployment units. Thus, an SCP node based on independent deployment units is possible, as described in 3GPP TS 23.501 V16.4.0. In other embodiments, the second SCP node may be deployed as a distributed network element. For example, in some embodiments, part (e.g. a service agent) of the second SCP node may be deployed in the same deployment unit as any one or more of the first NF nodes 30, 70, 90 and/or part (e.g. a service agent) of the second SCP node may be deployed in the same deployment unit as the NRF node 60. Thus, an SCP node based on a service mesh is possible, as described in 3GPP TS 23.501 V16.4.0.

In some embodiments, at least one third SCP node may be configured to operate as an SCP between the second NF node 20 and the first SCP node, and/or at least one fourth SCP node may be configured to operate as an SCP between the first SCP node and the NRF node 60. Similarly, in some embodiments, at least one fifth SCP node may be configured to operate as an SCP between the NRF node 60 and the second SCP node, and/or at least one sixth SCP node may be configured to operate as an SCP between the second SCP node and any one or more of the first NF nodes 30, 70, 90. Thus, a multipath of SCP nodes is possible. In some of these embodiments, the first SCP node and one or more of the at least one third SCP node and the at least one fourth SCP node may be deployed in independent deployment units. In some embodiments, the at least one third SCP node and/or the at least one fourth SCP node may be deployed as distributed network elements. In some embodiments, the second SCP node and one or more of the at least one fifth SCP node and the at least one sixth SCP node may be deployed in independent deployment units. In some embodiments, the at least one fifth SCP node and/or the at least one sixth SCP node may be deployed as distributed network elements.

At steps 500 to 518 of FIG. 9, the method described earlier with respect to steps 100 to 118 of FIG. 6 respectively is performed. The only exception is that at step 516 of FIG. 9, the discovery response comprises a flag that indicates to the second NF node that the NRF node 60 has altered the priority information, e.g. “altered-priorities-in-results”. This flag allows the second NF node 20 to consider its policy with respect to the caching of profiles, as well as allowing a new subscription request (which will be discussed below).

As illustrated by arrow 520 of FIG. 9, the second NF node 20 transmits a (existing) subscription request towards the NRF node 60 (e.g. directly or indirectly such as via the first SCP node) and the NRF node 60 receives the subscription request. The subscription request is a request for the NRF node 60 to notify the second NF node 20 of updates to a profile of any first NF nodes 30 of the plurality of first NF nodes 30, 70, 90. This is a standard subscription request. In some embodiments, it may instead be executed prior to step 512 of FIG. 9. As illustrated by arrow 522 of FIG. 9, the NRF node 60 transmits a response to the subscription request towards the second NF node 20 (e.g. directly or indirectly such as via the first SCP node) and the second NF node receives the response. Thus, the second NF node 20 subscribes to be notified if profile(s) of the first NF node(s) 30, 70, 90 are modified.

As illustrated by arrow 524 of FIG. 9, the second NF node 20 transmits a message towards the NRF node 60 (e.g. directly or indirectly such as via the first SCP node) and the NRF node 60 receives the message. This message 524 is referred to herein as the “second message”. The second message 524 comprises the information indicative of the plurality of criteria and the order of importance of the plurality of criteria. This is a new query parameter, which may be referred to as “preferences-precedence”. In the embodiment illustrated in FIG. 9, the plurality of criteria comprises “preferred-tai=TAI-x” and “preferred-vendor-specific-nf-features=y” and the order of importance of the plurality of criteria is “preferred-tai, preferred-vendor-specific-nf-features”. The first criterion in the list takes precedence over the second criterion in the list (and, similarly, the second criterion in the list takes precedence over the third criterion in the list, the third criterion in the list take precedence over the fourth criterion in the list, and so on).

Thus, the order of importance provided indicates that “preferred-tai=TAI-x” takes precedence over “preferred-vendor-specific-nf-features”. The second message 524 also comprises information indicative (e.g. a list) of the plurality of first NF nodes 30, 70, 90 for providing the service. This allows that the NRF node 60 to identify to which first NF nodes the subscription corresponds. A single second message 524 may be sent for all first NF nodes 30, 70, 90, as illustrated in FIG. 9, or a separate second message 524 may be sent for each of the first NF nodes 30, 70, 90.

The second message 524 is a (new) subscription request. The subscription request 524 is a request for the NRF node 60 to notify the second NF node 20 of updates to the priority information assigned to any first NF nodes 30 of the plurality of first NF nodes 30, 70, 90. The subscription request 524 may be a new service of the NRF node 60 or a new operation of an existing service of the NRF node 60 (e.g. Nnrf_NFMng). The subscription request thus includes the same preferences and their precedence as in the discovery request 112. Alternatively, an identifier that identifies the previous discovery results (“search Id”) may be included in the subscription request. This identifier can be returned to the second NF node 20 from the NRF node 60 in a previous discovery response. In some embodiments, this step may be executed prior to step 512 of FIG. 9.

As illustrated by arrow 526 of FIG. 9, the NRF node 60 transmits a response to the subscription request towards the second NF node 20 (e.g. directly or indirectly such as via the first SCP node) and the second NF node 20 receives the response. Thus, the second NF node 20 subscribes to be notified if the priority information of the first NF node(s) 30, 70, 90 is modified. As illustrated at block 528 of FIG. 9, the NRF node 60 stores the information indicative of the plurality of criteria and the order of importance of the plurality of criteria, optionally with the information indicative of the plurality of first NF nodes 30, 70, 90 for providing the service, and optionally also with any other subscription information.

There may be a reason for the NRF node 60 to trigger a redetermination of the priority information of a first NF node 30. For example, the former provided altered priority information may be overwritten by an update of the first NF node profile. In this case, the NRF node 60 may either remove the priority information from the updated profile that so the second NF node 20 knows the former one is valid or the NRF node 60 may redetermine the priority information and provide it again to the second NF node 20. In another example, the former provided altered priority information may need to be modified. This can, for example, occur when any parameter (e.g. priority itself, load, capacity, etc.) in the first NF node profile that is used for determination of priority information is modified. This can also occur when there are other criteria (e.g. configurable in the NRF node 60) that affect the priority information, e.g. a health status of the first NF node that is supervised by the NRF node 60. In this case, the NRF node 60 may need to provide new priority information to the second NF node 20.

In the embodiment illustrated in FIG. 9, as illustrated by block 529, there may be a trigger other than an update to a profile of a first NF node 30 that requires that the NRF node 60 provides altered priority information for the first NF node 30. For example, a health supervision of the first NF node 30 may indicate that this is required. Alternatively, there may be an update to a profile of the first NF node 30 that means that the priority information of the first NF node 30 needs to be altered. For example, it can be a change to the priority information in the profile or a change to another attribute (e.g. load, capacity, allowed NF types, etc.) in the profile that the NRF node 60 previously used to determine the priority information for the first NF node 30. In this case, as illustrated by arrow 530 of FIG. 9, the first NF node 30 transmits a registration request towards the NRF node 60 and the NRF node 60 receives the registration request 530. The registration request 530 comprises the updated profile for the first NF node 30 and requests that it is registered. The first NF node 30 provides priority information in the profile similar to its first registration (e.g. a priority value of “3”). As illustrated by arrow 532 of FIG. 9, the NRF node 60 transmits a response to the registration request 530 towards the first NF node 30 and the first NF node 30 receives the response 532.

As illustrated by block 534 of FIG. 9, the NRF node 60 assigns priority information to the first NF node 30 according to the stored information indicative of the plurality of criteria and the order of importance of the plurality of criteria. This can result in the priority information in the updated profile received from the first NF node 30 being modified. The NRF node 60 prepares a notification request and identifies any second NF node subscribed to updates to a profile of any first NF nodes 30 of the plurality of first NF nodes 30, 70, 90. If the priority information itself, or other parameters that are used by the NRF node 60 to determine priority information (e.g. load, capacity, etc.) are modified, then the NRF node 60 needs to redetermine the previously altered priority information and include that in the notification request. The NRF node 60 updates the priority information according to stored preferences and their precedence and optionally any extra criteria (similarly as for the discovery result 112). It may be that the same criteria are used to obtain the priority information as the criteria that is used at step 414 of FIG. 8. In an example, if the parameter “AllowedNFtypes” is modified but this does not require modification of the first NF node order for selection (or reselection), then the priority information does not need to be changed. In this case, the NRF node 60 may either not include the priority information in the notification request (so that the second NF node 20 knows the former priority information is valid) or the same priority information may be included in the notification request.

The storage of the information indicative of the plurality of first NF nodes 30, 70, 90 for providing the service (as part of the subscription) allows the NRF node 60 to modify the priority information not only for one individual first NF node but, if required, the priority information for more than one first NF node. This allows the NRF node 60 to perform a reordering of the previous priority information provided in the former discovery response 516 and send the corresponding notification with the updated priority information, e.g. to all the affected first NF nodes.

As illustrated by arrow 536 of FIG. 9, the NRF node 60 transmits a notification request towards the second NF node 20 (e.g. directly or indirectly such as via the first SCP node) and the second NF node 20 receives the notification request 532. This is a standard notification request. As illustrated by arrow 538 of FIG. 9, the second NF node 20 transmits a response to the notification request 536 towards the NRF node 60 (e.g. directly or indirectly such as via the first SCP node) and the NRF node 60 receives the response. The notification request 538 may comprise information indicative of an update to a profile of one or more first NF nodes 30 of the plurality of first NF nodes 30, 70, 90.

As illustrated by arrow 540 of FIG. 9, the NRF node 60 transmits another notification request towards the second NF node 20 (e.g. directly or indirectly such as via the first SCP node) and the second NF node 20 receives the notification request 432. This notification request 540 is referred to herein as the “fifth message”. As illustrated by arrow 542 of FIG. 9, the second NF node 20 transmits a response to the notification request 540 towards the NRF node 60 (e.g. directly or indirectly such as via the first SCP node) and the NRF node 60 receives the response. The notification request 540 comprises information indicative of an update to the priority information assigned to one or more first NF nodes 30 of the plurality of first NF nodes 30, 70, 90. The notification requests 536, 540 may also be referred to herein as subscription responses. The notification request 540 is separate from the notification request 536.

Thus, if priority information needs to be altered, the NRF node 60 can send a new notification request 540 with the corresponding altered priority information. If priority information needs to be modified for more than one first NF node, then either this notification request 540 includes the modified priority information for all of those first NF nodes or multiple notification requests may be sent. This allows the NRF node 60 to inform the second NF node 20 about a reordering of the previously discovered results.

Thus, as illustrated by block 544 of FIG. 9, the second NF node 20 receives the priority information assigned by the NRF node 60 at block 534 of FIG. 9. The priority information received for the first NF node 30 at step 515 of FIG. 9 (as assigned by the NRF node 60) can be overwritten by the priority information received for the first NF node 30 at step 540 of FIG. 9 (as also assigned by the NRF node 60). The priority information in the updated profile received for the first NF node 30 in the regular notification request 536 (and that is not assigned by the NRF node 60) can also be overwritten by the priority information received for the first NF node 30 in the new notification request 540 (and that is assigned by the NRF node 60). Alternatively, where there is no priority information included in the notification request 540, the former priority information that the second NF node 20 received at step 516 of FIG. 9 (as assigned by the NRF node 60) remains valid.

The selection of a first NF node based on the priority information is therefore improved due to the advantageous manner in which this priority information is assigned by the NRF node 60. In the embodiment illustrated in FIG. 9, the new subscription may be to only get altered priority information whenever it is necessary to refresh it. The existing subscription request 536 remains unchanged and the new notification request 540 is used to notify the altered priority information. This can be beneficial to avoid impacting existing NRF subscription to allow the second NF node 20 to receive the real first NF node profile and to avoid a close linkage between two different services in the NRF node 60 due to the need to include preferences and their precedence as input parameters to the discovery process.

FIG. 10 is a signalling diagram illustrating an exchange of signals in a system according to an embodiment. The system illustrated in FIG. 10 comprises a network node 20 and an NRF node 60. The system illustrated in FIG. 10 may optionally also comprise a plurality of first NF nodes 30, 70, 90 of a service producer (“NFp1”, “NFp2”, “NFp3”). Although three first NF nodes 30, 70, 90 are illustrated, the system illustrated in FIG. 10 can comprise one or more first NF nodes. The plurality of first NF nodes 30, 70, 90 can each be configured to provide a service. The first NF nodes 30, 70, 90 can be part of a set of NF service producer nodes according to some embodiments.

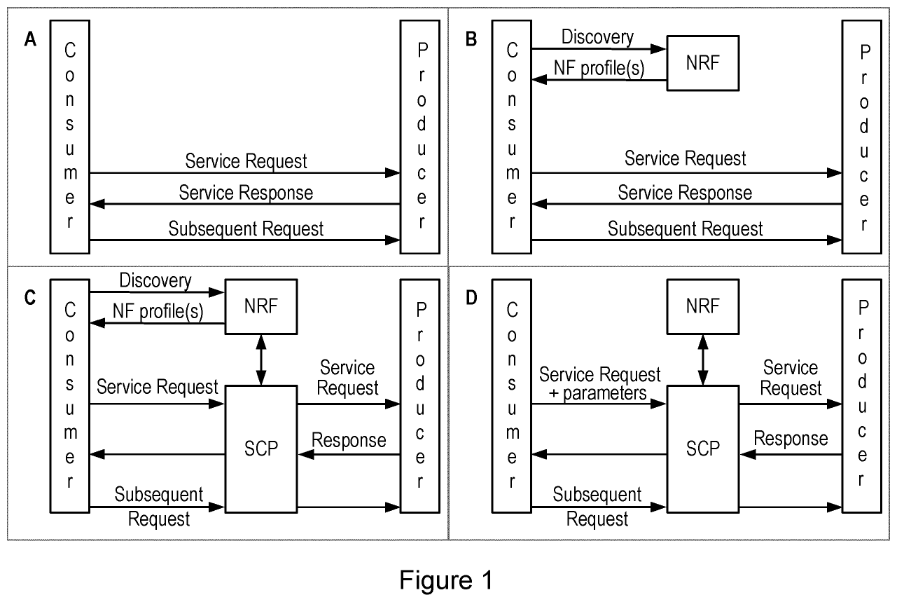

As illustrated in FIG. 1C, the network node 20 can be a second NF node of a service consumer (“NFc”) according to some embodiments. However, in other embodiments (not illustrated), the network node 20 can be a first SCP node. Thus, the method described herein with respect to the second NF node 20 may instead be performed by the first SCP node. In these embodiments, the first SCP node is configured to operate as an SCP between second NF node 20 and the NRF node 60. Similarly, a second SCP node may be configured to operate as an SCP between the NRF node 60 and any one or more of the first NF nodes 30, 70, 90.

In some embodiments where the system comprises the first SCP node, an entity may comprise the first SCP node and the NRF node 60. That is, in some embodiments, the first SCP node can be merged with the NRF node 60 in a combined entity. In some embodiments where the system comprises the second SCP node, an entity may comprise the second SCP node and the NRF node 60. That is, in some embodiments, the second SCP node can be merged with the NRF node 60 in a combined entity. The system illustrated in FIG. 10 can comprise one or more SCP nodes according to some embodiments.

In some embodiments, the first SCP node and the second NF node 20 may be deployed in independent deployment units, and/or the first SCP node and the NRF node 60 may be deployed in independent deployment units. Thus, an SCP node based on independent deployment units is possible, as described in 3GPP TS 23.501 V16.4.0. In other embodiments, the first SCP node may be deployed as a distributed network element. For example, in some embodiments, part (e.g. a service agent) of the first SCP node may be deployed in the same deployment unit as the second NF node 20, and/or part (e.g. a service agent) of the first SCP node may be deployed in the same deployment unit as the NRF node 60. Thus, an SCP node based on a service mesh is possible, as described in 3GPP TS 23.501 V16.4.0.

In some embodiments, the second SCP node and any one or more of the first NF nodes 30, 70, 90 may be deployed in independent deployment units, and/or the second SCP node and the NRF node 60 may be deployed in independent deployment units. Thus, an SCP node based on independent deployment units is possible, as described in 3GPP TS 23.501 V16.4.0. In other embodiments, the second SCP node may be deployed as a distributed network element. For example, in some embodiments, part (e.g. a service agent) of the second SCP node may be deployed in the same deployment unit as any one or more of the first NF nodes 30, 70, 90 and/or part (e.g. a service agent) of the second SCP node may be deployed in the same deployment unit as the NRF node 60. Thus, an SCP node based on a service mesh is possible, as described in 3GPP TS 23.501 V16.4.0.

In some embodiments, at least one third SCP node may be configured to operate as an SCP between the second NF node 20 and the first SCP node, and/or at least one fourth SCP node may be configured to operate as an SCP between the first SCP node and the NRF node 60. Similarly, in some embodiments, at least one fifth SCP node may be configured to operate as an SCP between the NRF node 60 and the second SCP node, and/or at least one sixth SCP node may be configured to operate as an SCP between the second SCP node and any one or more of the first NF nodes 30, 70, 90. Thus, a multipath of SCP nodes is possible. In some of these embodiments, the first SCP node and one or more of the at least one third SCP node and the at least one fourth SCP node may be deployed in independent deployment units. In some embodiments, the at least one third SCP node and/or the at least one fourth SCP node may be deployed as distributed network elements. In some embodiments, the second SCP node and one or more of the at least one fifth SCP node and the at least one sixth SCP node may be deployed in independent deployment units. In some embodiments, the at least one fifth SCP node and/or the at least one sixth SCP node may be deployed as distributed network elements.

At steps 700 to 714 of FIG. 10, the method described earlier with respect to steps 100 to 114 of FIG. 6 respectively is performed. The only exception is that at step 712 of FIG. 10, the discovery response comprises a flag to indicate to the NRF node 60 that the second NF node 20 requires to subscribe to changes to priority information. This allows the second NF node 20 to cache discovered results (even with altered priority information) since the second NF node 20 is able to acquire priority information updates from a notification request (which will be discussed below).

As illustrated at block 716 of FIG. 10, the NRF node 60 (locally) stores in a memory 64 of the NRF node 60 any one or more of the information indicative of the plurality of first NF nodes 30, 70, 90 for providing the service and the information indicative of the plurality of criteria and the order of importance of the plurality of criteria. This storage is performed if the flag is present in the discovery response 712. Thus, the NRF node 60 stores locally the received preferences and their precedence and/or the discovered first NF nodes 30, 70, 90 based on the executed discovery. This allows the NRF node 60 to redetermine the priority information for any of the discovered first NF nodes 30, 70, 90. The storage also enables execution of what the subscription requires.

As illustrated by arrow 718 of FIG. 10, the NRF node 60 transmits a message towards the second NF node 20 (e.g. directly or indirectly such as via the first SCP node) and the second NF node 20 receives the message. This message is referred to herein as the “third message”. The third message 718 comprises an identifier (e.g. URI). The identifier indicates to the second NF node 20 that the NRF node 60 has altered the priority information. The second NF node 20 can offer the identifier to send a new subscription request to the NRF node 60 to be informed of changes to priority information. The identifier allows the second NF node 20 to consider its policy with respect to the caching of first NF profiles, as well as allowing a new subscription request (which will be described below).

At steps 720 to 724 of FIG. 10, the method described earlier with respect to steps 518 to 522 of FIG. 9 respectively is performed.

As illustrated by arrow 726 of FIG. 10, the second NF node 20 transmits a message towards the NRF node 60 (e.g. directly or indirectly such as via the first SCP node) and the NRF node 60 receives the message. This message is referred to herein as the “first message”. In the embodiment illustrated in FIG. 10, the first message 726 comprises the identifier and thus the identifier is the information indicative of the plurality of criteria and the order of importance of the plurality of criteria. More specifically, the identifier allows the information indicative of the plurality of criteria and the order of importance of the plurality of criteria to be retrieved from the memory 64 of the NRF node 60. This first message enables a new subscription to the identifier provided in discovery results at step 718 of FIG. 10. The second NF node 20 subscribes to be notified if the received priority information needs to be modified. In this case, however, it is not necessary to include the same preferences and their precedence as in the discovery request 712, or any other information, since the identifier provided by the NRF node 60 is specifically for this type of subscription and holds the information provided by the discovery request 712.

As illustrated by arrow 728 of FIG. 10, the NRF node 60 transmits a response to the first message and the second NF node 20 receives the response. As illustrated at block 730 of FIG. 10, the NRF node 60 stores subscription information to be able to send notifications to the indicated destination.

At steps 731 to 746 of FIG. 10, the method described earlier with respect to steps 529 to 544 of FIG. 9 respectively is performed. The only exception is that, with respect to block 736 of FIG. 10, the information about preferences, their precedence, and discovered first NF node(s) 30, 70, 90 is cached by the NRF node 60 at step 716 (as a result of the discovery), rather than at step 730 (as a result of the new subscription). As with the other embodiments, the selection of a first NF node based on the priority information is advantageously improved due to the advantageous manner in which this priority information is assigned by the NRF node 60.

FIG. 11 is a signalling diagram illustrating an exchange of signals in a system according to an embodiment. The system illustrated in FIG. 11 comprises a network node 20 and an NRF node 60. The system illustrated in FIG. 11 may optionally also comprise a plurality of first NF nodes 30, 70, 90 of a service producer (“NFp1”, “NFp2”, “NFp3”). Although three first NF nodes 30, 70, 90 are illustrated, the system illustrated in FIG. 11 can comprise one or more first NF nodes. The plurality of first NF nodes 30, 70, 90 can each be configured to provide a service. The first NF nodes 30, 70, 90 can be part of a set of NF service producer nodes according to some embodiments.

As illustrated in FIG. 11, the network node 20 can be a second NF node of a service consumer (“NFc”) according to some embodiments. However, in other embodiments (not illustrated), the network node 20 can be a first SCP node. Thus, the method described herein with respect to the second NF node 20 may instead be performed by the first SCP node. In these embodiments, the first SCP node is configured to operate as an SCP between second NF node 20 and the NRF node 60. Similarly, a second SCP node may be configured to operate as an SCP between the NRF node 60 and any one or more of the first NF nodes 30, 70, 90.

In some embodiments where the system comprises the first SCP node, an entity may comprise the first SCP node and the NRF node 60. That is, in some embodiments, the first SCP node can be merged with the NRF node 60 in a combined entity. In some embodiments where the system comprises the second SCP node, an entity may comprise the second SCP node and the NRF node 60. That is, in some embodiments, the second SCP node can be merged with the NRF node 60 in a combined entity. The system illustrated in FIG. 11 can comprise one or more SCP nodes according to some embodiments.

In some embodiments, the first SCP node and the second NF node 20 may be deployed in independent deployment units, and/or the first SCP node and the NRF node 60 may be deployed in independent deployment units. Thus, an SCP node based on independent deployment units is possible, as described in 3GPP TS 23.501 V16.4.0. In other embodiments, the first SCP node may be deployed as a distributed network element. For example, in some embodiments, part (e.g. a service agent) of the first SCP node may be deployed in the same deployment unit as the second NF node 20, and/or part (e.g. a service agent) of the first SCP node may be deployed in the same deployment unit as the NRF node 60. Thus, an SCP node based on a service mesh is possible, as described in 3GPP TS 23.501 V16.4.0.

In some embodiments, the second SCP node and any one or more of the first NF nodes 30, 70, 90 may be deployed in independent deployment units, and/or the second SCP node and the NRF node 60 may be deployed in independent deployment units. Thus, an SCP node based on independent deployment units is possible, as described in 3GPP TS 23.501 V16.4.0. In other embodiments, the second SCP node may be deployed as a distributed network element. For example, in some embodiments, part (e.g. a service agent) of the second SCP node may be deployed in the same deployment unit as any one or more of the first NF nodes 30, 70, 90 and/or part (e.g. a service agent) of the second SCP node may be deployed in the same deployment unit as the NRF node 60. Thus, an SCP node based on a service mesh is possible, as described in 3GPP TS 23.501 V16.4.0.

In some embodiments, at least one third SCP node may be configured to operate as an SCP between the second NF node 20 and the first SCP node, and/or at least one fourth SCP node may be configured to operate as an SCP between the first SCP node and the NRF node 60. Similarly, in some embodiments, at least one fifth SCP node may be configured to operate as an SCP between the NRF node 60 and the second SCP node, and/or at least one sixth SCP node may be configured to operate as an SCP between the second SCP node and any one or more of the first NF nodes 30, 70. Thus, a multipath of SCP nodes is possible. In some of these embodiments, the first SCP node and one or more of the at least one third SCP node and the at least one fourth SCP node may be deployed in independent deployment units. In some embodiments, the at least one third SCP node and/or the at least one fourth SCP node may be deployed as distributed network elements. In some embodiments, the second SCP node and one or more of the at least one fifth SCP node and the at least one sixth SCP node may be deployed in independent deployment units. In some embodiments, the at least one fifth SCP node and/or the at least one sixth SCP node may be deployed as distributed network elements.

The method illustrated in FIG. 11 can follow on from the methods described earlier with respect to FIG. 8, 9 or 10, as illustrated by the dotted lines in each of these figures. At steps 800 to 804 of FIG. 11, the method described earlier with respect to steps 425 to 430 of FIG. 8 respectively, steps 529 to 534 of FIG. 9 respectively, or steps 731 to 736 of FIG. 10 respectively is performed.

At block 806 of FIG. 11, the method described earlier with respect to steps 432 to 436 of FIG. 8 respectively is performed. The only exception is that, unlike the notification request 432 in FIG. 8, the notification request 810 in FIG. 11 includes an indication of “Reorder required”. This indication can be optionally included by the NRF node 60 when it identifies that reordering of the first NF nodes 30, 70, 90 previously provided in a discovery result is needed. This may occur, for example, when the criteria to modify priority information is dependent on the time of the day, or another variable, that will simultaneously affect multiple or all first NF nodes 30, 70, 90.

The notification request 810 is referred to herein as the “fourth message”. In more detail, as illustrated by arrow 810 of FIG. 11, the NRF node 60 transmits the fourth message towards the network node 20. The fourth message 810 comprises information indicative that the network node 20 is to initiate transmission of a discovery request towards the NRF node 60. The discovery request is a request for information indicative of an alternative plurality of first NF nodes 30, 70, 90 for providing the service and comprises the information indicative of the plurality of criteria and the order of importance of the plurality of criteria. At step 812 of FIG. 11, the method described earlier with respect to step 434 of FIG. 8 is performed.

At block 808 of FIG. 11, the method described earlier with respect to steps 536 to 544 of FIG. 9 respectively or the method described earlier with respect to steps 738 to 746 of FIG. 10 respectively are performed. The only exception is that, unlike the notification request 540 in FIG. 9 or the notification request 742 in FIG. 10, the notification request 818 in FIG. 11 includes an indication of “Reorder required”. This functionality can be used when the NRF node 60 knows that the provided discovery results may not (or may no longer) be valid, for example, due to some NRF node 60 processing or alteration. For example, the NRF node 60 may have a policy to filter out some first NF nodes, which means that the discovered first NF nodes will not be valid and alternative first NF nodes need to be provided.

The notification request 818 is referred to herein as the “fourth message”. In more detail, as illustrated by arrow 818 of FIG. 11, the NRF node 60 transmits the fourth message towards the network node 20. The fourth message 818 comprises information indicative that the network node 20 is to initiate transmission of a discovery request towards the NRF node 60. The discovery request is a request for information indicative of an alternative plurality of first NF nodes 30, 70, 90 for providing the service and comprises the information indicative of the plurality of criteria and the order of importance of the plurality of criteria. At steps 814, 816, 820 of FIG. 11, the method described earlier with respect to steps 536, 538, 542 of FIG. 9 respectively or steps 738, 740, 744 of FIG. 10 respectively are performed.

In some embodiments, the stored cache of former discovery results may be refreshed or cleaned at the NRF node 60 and/or the second NF node 20. In some embodiments, the former discovery results may be deleted at the NRF node 60 and/or the second NF node 20. If the “Reorder required” indication is not received, the NRF node 60 and/or the second NF node 20 may keep the priority information as it is.

As illustrated by arrow 822 of FIG. 11, the second NF node 20 transmits a discovery request towards the NRF node 60 in response to receiving the fourth message 810, 818 from the NRF node 60. The NRF node 60 receives the discovery request 822 from the network node 20. The discovery request 822 is a request for information indicative of an alternative plurality of first NF nodes 30, 70, 90 for providing the service and comprises the information indicative of the plurality of criteria and the order of importance of the plurality of criteria. Thus, the discovery request 822 can start any of the processes described earlier from the original discovery request again.

As described with reference to FIG. 11, the NRF node 60 can inform the second NF node 20 that a re-ordering of previously altered priorities is required. In some embodiments described herein, it may be required that the NRF node 60 is able to alter the priority of one first NF node independently of the rest of the first NF nodes. This can require a priority alteration procedure that takes into account all possible modifications that may occur, e.g. along the lifetime of the caching of discovery results. The method described with respect to FIG. 11 can avoid the need for this procedure and allow that an event or modification of attributes in first NF profile(s) requires a modification to formerly altered priorities. The notification requests 810, 818 in FIG. 11 may not include the (e.g. modified) priority information or, if they do, the second NF node 20 may be configured not to consider them.

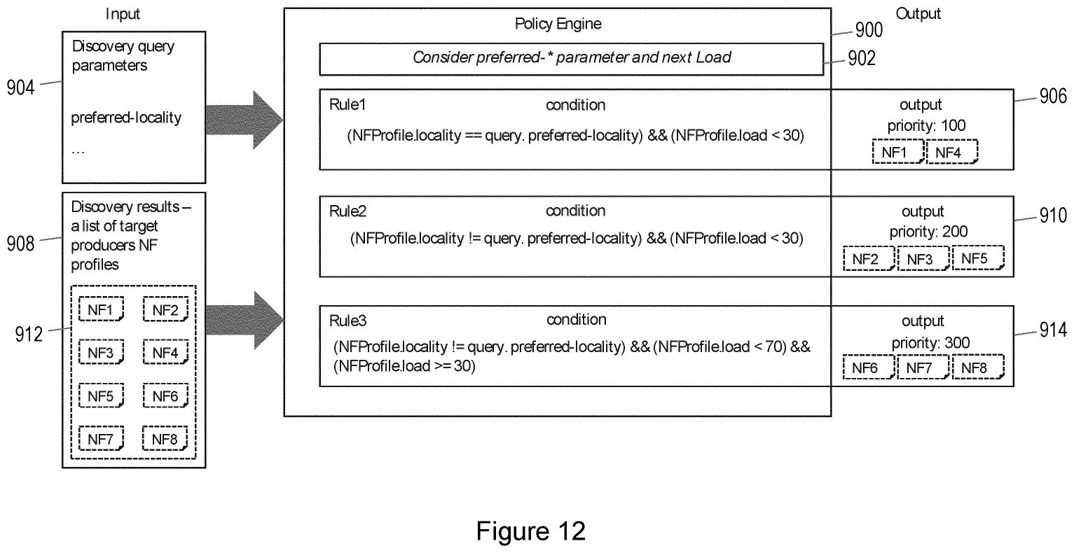

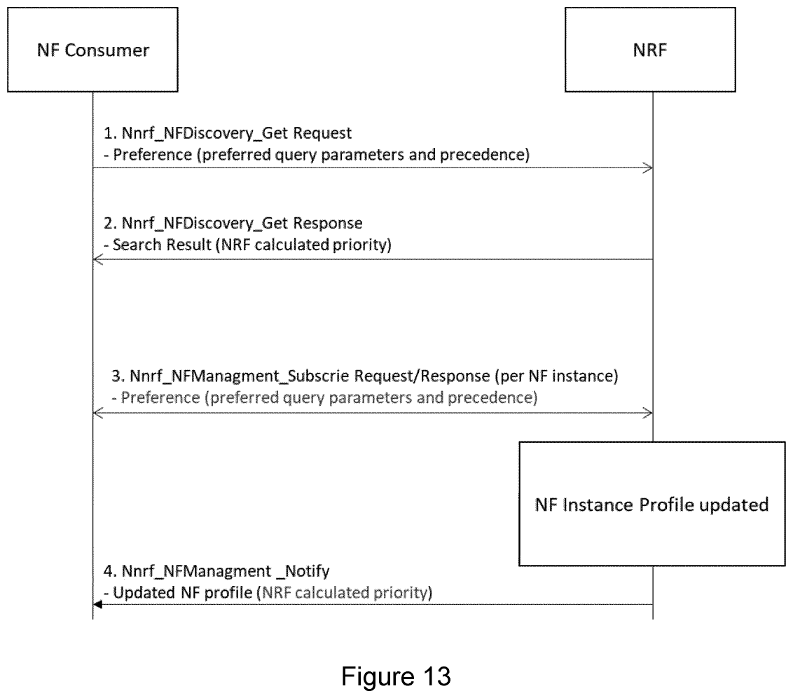

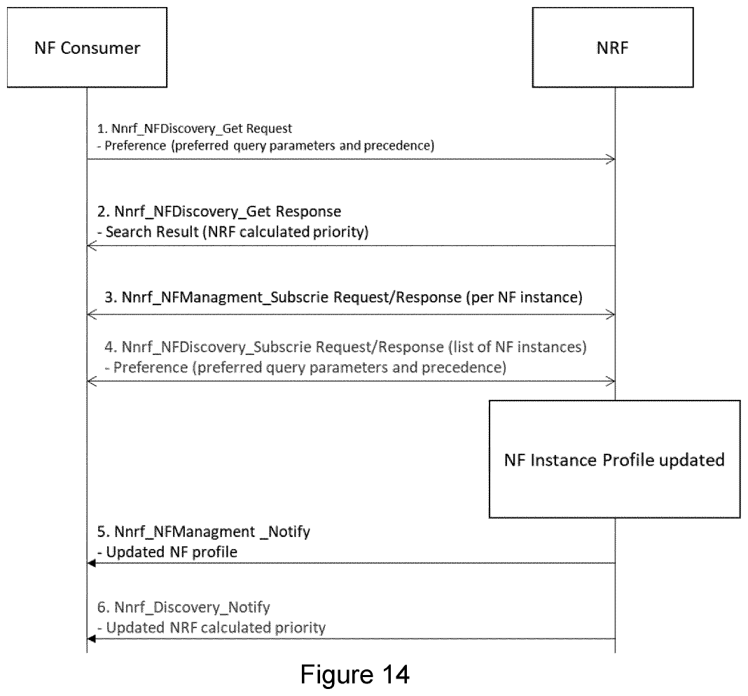

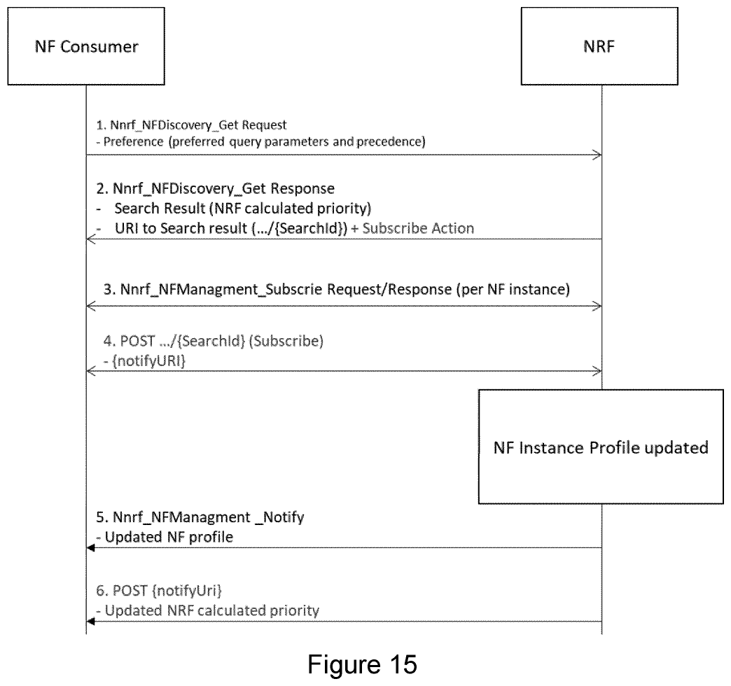

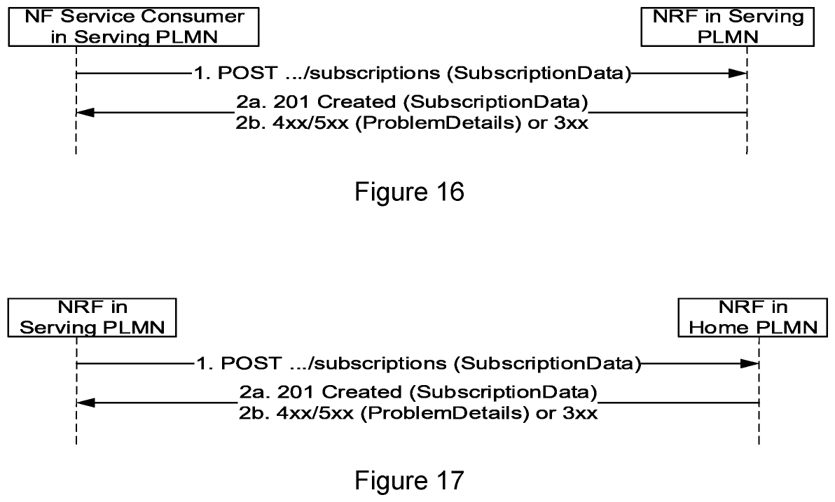

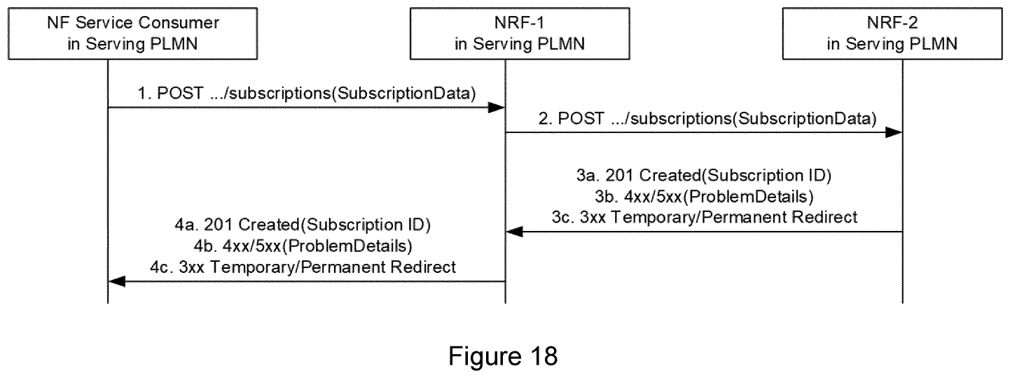

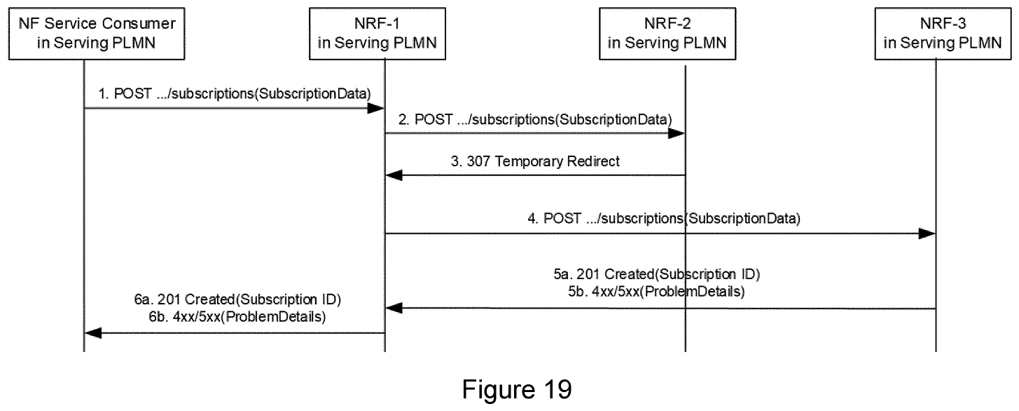

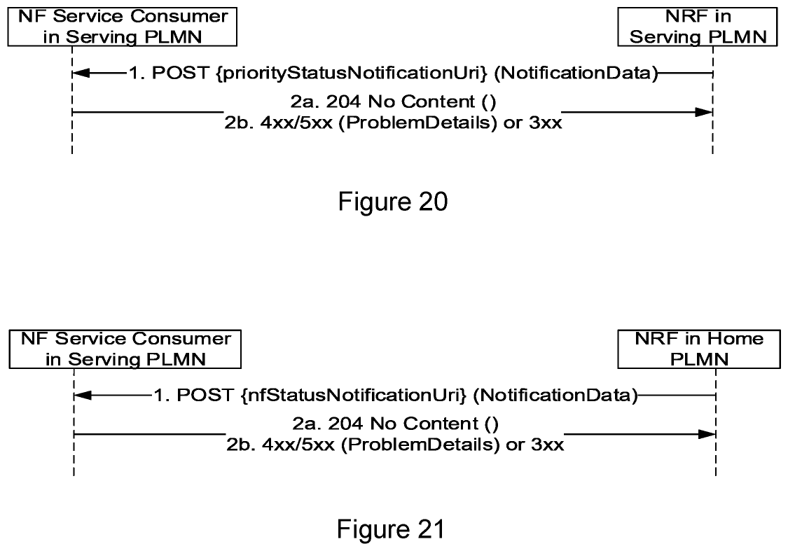

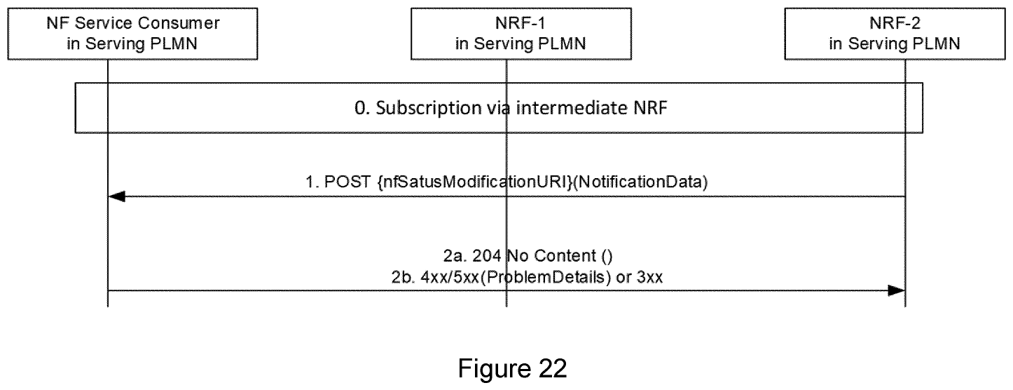

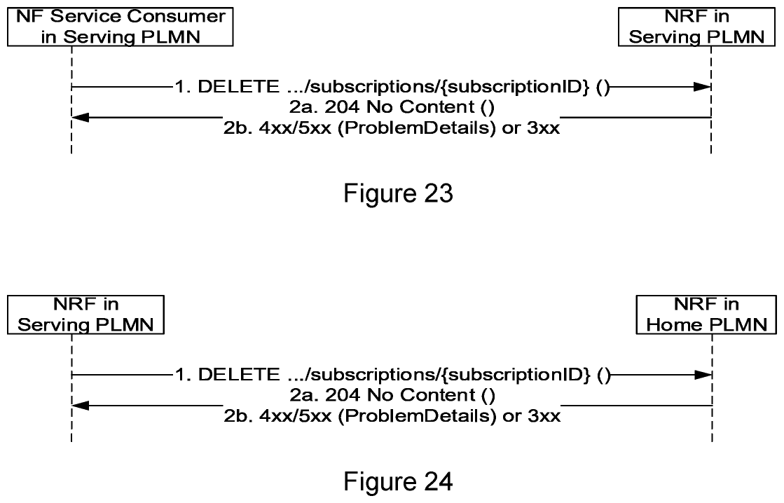

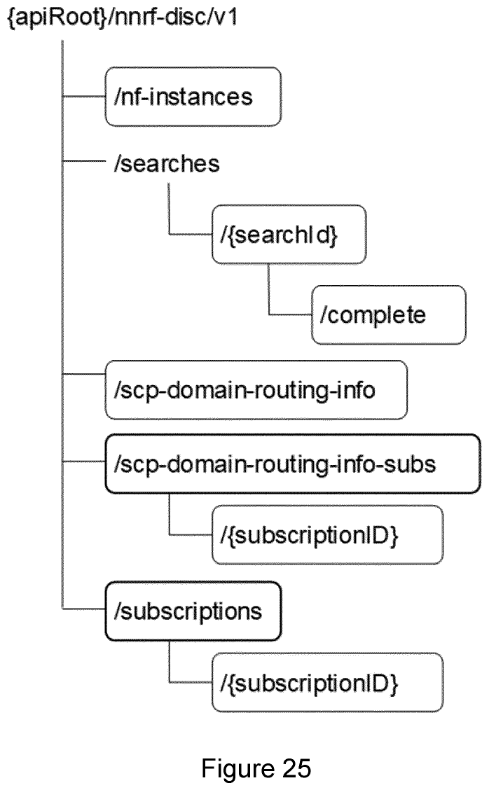

FIG. 12 illustrates a system according to an embodiment. As illustrated in FIG. 12, the system comprises a policy engine 900. The NRF node 60 can comprise the policy engine 900. The system of FIG. 12 illustrates an example way in which priority information may be assigned to a plurality of first NF nodes. The input into the policy engine 900 can comprise the one or more discovery query parameters 904 (e.g. preferred-locality and/or any other query parameters) and discovery results 908. The discovery results can, for example, comprise a list 912 of profiles for the plurality of first NF nodes. As illustrated by block 902 of FIG. 12, the policy engine 900 considers the one or more preferred parameters. The policy engine applies a plurality of rules to output priority information 906, 910, 914 for the plurality of first NF nodes.

In some embodiments, an altered-priority algorithm may be used to modify the priority information for each first NF node independently. This can allow control over how modification of the priority information for one first NF node may impact altered priority information for other first NF nodes.

In some embodiments, the rules used by the NRF node 60 to modify the priority information is based on the second NF node 20 preferences (e.g. preferred locality) and their precedence, and optionally also the first NF node attributes (e.g. locality, priority, load). The rules may also be based on other parameters/configurations, which are not dependent on the first NF profiles. An example is as follows, where “NFpX” represents a first NF node:
NFp1: Locality X, Priority 1, Load: 50
NFp2: Locality X, Priority 1, Load: 40
NFp3: Locality X, Priority 3, Load: 10
NFp4: Locality X, Priority 2, Load: 70
NFp5: Locality Y, Priority 1, Load: 80
NFp6: Locality Y, Priority 2, Load: 30
NFp7: Locality Z, Priority 1, Load: 0

The NRF node 60 may define the priority information based on offsets to allow priority information for each first NF node to be determined independently of other first NF nodes. A possible algorithm for assigning modified priority information to the above first NF nodes is as follows:

```
Offset=0
IF NFp Locality = preferredLocality THEN
  For each NFpx from lowest Priority repeat
    if there are more than one with same Priority repeat:
      NFp Priority=Offset+NFpPriority+Load
    Offset=Offset+100
    NFp Priority=Offset+NFpPriority+Load
IF NFp Locality != preferredLocality THEN
  For each NFpx from lowest Priority repeat
    if there are more than one with same Priority repeat:
      NFp Priority=Offset+NFpPriority+Load
    Offset=Offset+100
    NFp Priority=Offset+NFpPriority+Load
```

For the above example, the results will be:
NFp1: 0+1+50=52
NFp2: 0+1+40=41
NFp4: 100+2+70=272
NFp3: 200+3+10=313
NFp5: 300+1+80=381
NFp7: 300+1+0=301
NFp6: 400+2+30=432

Another example is as follows, where “NFpX” represents a first NF node and “NFpX-Y” represents an instance of a network node:
NFp1-B: with Load: 50%: priority: 50
NFp1-A: with Load: 70%: priority: 70
NFp2: priority 101
NFp3: priority 201

A possible algorithm for assigning modified priority information to the above first NF nodes and instances thereof is as follows:

Rule1 IF (NFprofile.load >=50)
THEN priority=original priority+load value
EXEC NEXT RULE
Rule2 IF (subsc/discovery.preferred-tai in
NFprofile.taList)&(subscription/discovery.preferred-features=NFprofile.supportfeatures)
THEN priority=original priority
EXIT
Rule3 IF (subsc/discovery.preferred-tai in NFprofile.taList)
THEN priority=original priority + 100
EXIT
Rule4 IF (subscription/discovery.preferred-features=NFprofile.supportfeatures)
THEN priority=original priority + 200
EXIT

There is also provided a computer program comprising instructions which, when executed by processing circuitry (such as the processing circuitry 22 of the network node 20 described earlier and/or the processing circuitry 62 of the NRF node 60 described earlier), cause the processing circuitry to perform at least part of the method described herein. There is provided a computer program product, embodied on a non-transitory machine-readable medium, comprising instructions which are executable by processing circuitry (such as the processing circuitry 22 of the network node 20 described earlier and/or the processing circuitry 62 of the NRF node 60 described earlier) to cause the processing circuitry to perform at least part of the method described herein. There is provided a computer program product comprising a carrier containing instructions for causing processing circuitry (such as the processing circuitry 22 of the network node 20 described earlier and/or the processing circuitry 62 of the NRF node 60 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

Other embodiments include those defined in the following numbered statements:

Embodiment 1. A method for prioritising a plurality of first NF nodes (30, 70, 90) of at least one service producer in a network, wherein the method is performed by a network node (20), the method comprising:
initiating transmission of a first message (112, 420, 524, 726) towards a network repository function, NRF, node (60),
   wherein the first message (112, 420, 524, 726) comprises information indicative of a plurality of criteria and an order of importance of the plurality of criteria,
   wherein the information is for use in assigning priority information to the plurality of first NF nodes (30, 70, 90), and
   wherein, for each first NF node (30) of the plurality of first NF nodes (30, 70, 90), the priority information assigned to the first NF node (30) is indicative of a priority with which the first NF node (30) is to be selected to provide a service relative to at least one other first NF node (70, 90) of the plurality of first NF nodes (30, 70, 90) and the priority information is assigned to the first NF node (30) based on one or more criteria of the plurality of criteria that the first NF node (30) meets and the position of the one or more criteria in the order of importance of the plurality of criteria.

Embodiment 2. A method according to Embodiment 1, wherein:
the first message (112, 420, 524, 726) comprises an array and the array comprises the information indicative of the plurality of criteria and the order of importance of the plurality of criteria,
wherein each item of the array comprises a different criterion of the plurality of criteria and the plurality of criteria are ordered in the array according to their importance.

Embodiment 3. A method according to Embodiment 1 or 2, wherein:
the plurality of criteria comprise any one or more of:
   a criterion indicative that first NF nodes (30, 70, 90) located at a predefined location are preferred; a criterion indicative that first NF nodes (30, 70, 90) serving a predefined tracking area identity, TAI, are preferred;
   a criterion indicative that a predefined instance of first NF nodes (30, 70, 90) are preferred;
   a criterion indicative that first NF nodes (30, 70, 90) supporting a predefined application programming interface, API, version of the service are preferred;
   a criterion indicative that first NF nodes (30, 70, 90) serving a full public land mobile network, PLMN, are preferred;
   a criterion indicative that first NF nodes (30, 70, 90) supporting one or more predefined vendor specific features for the service are preferred; and
   a criterion indicative that first NF nodes (30, 70, 90) supporting one or more predefined vendor specific features for the first NF nodes are preferred.

Embodiment 4. A method according to any of the preceding Embodiments, the method comprising:
initiating transmission of a second message (420, 524) towards the network repository function, NRF, node (60),
   wherein the second message (420, 524) comprises:
      the information indicative of the plurality of criteria and the order of importance of the plurality of criteria; and/or
      information indicative of the plurality of first NF nodes (30, 70, 90) for providing the service and, for each first NF node (30) of the plurality of first NF nodes (30, 70, 90), the priority information assigned to the first NF node (30).

Embodiment 5. A method according to Embodiment 4, wherein:
the second message (420, 524) is a first subscription request; and
the first subscription request (420) is a request for the NRF node (60) to notify the network node (20) of updates to a profile of any first NF nodes (30) of the plurality of first NF nodes (30, 70, 90); or
the first subscription request (524) is a request for the NRF node (60) to notify the network node (20) of updates to the priority information assigned to any first NF nodes (30) of the plurality of first NF nodes (30, 70, 90).

Embodiment 6. A method according to Embodiment 5, wherein:
the first subscription request (524) is separate from a second subscription request (520); and
the second subscription request (520) is a request for the NRF node (60) to notify the network node (20) of updates to a profile of any first NF nodes (30) of the plurality of first NF nodes (30, 70, 90).

Embodiment 7. A method according to any of Embodiments 1 to 3, wherein:
the first message (112) is a discovery request; and
the discovery request is a request for information indicative of the plurality of first NF nodes (30, 70, 90) for providing the service.

Embodiment 8. A method according to any of Embodiments 1 to 3, wherein:
the first message (420) is a subscription request; and
the subscription request is a request for the NRF node (60) to notify the network node (20) of updates to a profile of any first NF nodes (30) of the plurality of first NF nodes (30, 70, 90).

Embodiment 9. A method according to any of Embodiments 1 to 3, wherein:
the first message (524) is a first subscription request; and
the first subscription request (524) is a request for the NRF node (60) to notify the network node (20) of updates to the priority information assigned to any first NF nodes (30) of the plurality of first NF nodes (30, 70, 90).

Embodiment 10. A method according to Embodiment 9, wherein:
the first subscription request (524) comprises information indicative of the plurality of first NF nodes (30, 70, 90) for providing the service.

Embodiment 11. A method according to Embodiment 9 or 10, wherein:
the first subscription request (524) is separate from a second subscription request (520); and
the second subscription request (520) is a request for the NRF node (60) to notify the network node (20) of updates to a profile of any first NF nodes (30) of the plurality of first NF nodes (30, 70, 90).

Embodiment 12. A method according to any of Embodiments 1 to 3, wherein:
the first message (726) comprises an identifier; and
the identifier is the information indicative of the plurality of criteria and the order of importance of the plurality of criteria.

Embodiment 13. A method according to Embodiment 12, wherein:
the information indicative of the plurality of criteria and the order of importance of the plurality of criteria is an identity of a resource of the NRF (60) at which the information indicative of the plurality of criteria and the order of importance of the plurality of criteria is stored.

Embodiment 14. A method according to Embodiment 12 or 13, the method comprising:
receiving a third message (718) comprising the identifier from the NRF node (60).

Embodiment 15. A method according to Embodiment 14, wherein:
the third message (718) is a discovery response; and
the discovery response comprises information indicative of the plurality of first NF nodes (30, 70, 90) for providing the service and information indicative that the priority information has been assigned to the plurality of first NF nodes (30, 70, 90).

Embodiment 16. A method according to any of Embodiments 12 to 15, wherein:
the identifier is a uniform resource identifier, URI.

Embodiment 17. A method according to any of Embodiments 12 to 16, the method comprising:
initiating transmission of a discovery request (712) towards the NRF node (60),
   wherein the discovery request (712) is a request for information indicative of the plurality of first NF nodes (30, 70, 90) for providing the service, and
   wherein the discovery request (712) comprises information indicative that the network node (20) is to be subscribed to updates to the priority information assigned to any first NF nodes (30) of the plurality of first NF nodes (30, 70, 90).

Embodiment 18. A method according to any of the preceding Embodiments, the method comprising:
initiating transmission of a discovery request (822) towards the NRF node (60) in response to receiving a fourth message (810, 818) from the NRF node (60),
   wherein the fourth message (810, 818) comprises information indicative that the network node (20) is to initiate transmission of a discovery request towards the NRF node (60), and
   wherein the discovery request is a request for information indicative of an alternative plurality of first NF nodes (30, 70, 90) for providing the service and comprises the information indicative of the plurality of criteria and the order of importance of the plurality of criteria.

Embodiment 19. A method according to any of the preceding Embodiments, wherein:
the network node is a second NF node (20) of a service consumer; or
the network node is a first service communication proxy, SCP, node that is configured to operate as an SCP between the second NF node (20) and the NRF node (60).

Embodiment 20. A method for prioritising a plurality of first NF nodes (30, 70, 90) of at least one service producer in a network, wherein the method is performed by a network repository function, NRF, node (60), the method comprising:
receiving a first message (112, 420, 524, 726) from a network node (20),
   wherein the first message (112, 420, 524, 726) comprises information indicative of a plurality of criteria and an order of importance of the plurality of criteria; and
assigning (114, 430, 534, 736) priority information to the plurality of first NF nodes (30, 70, 90),
   wherein, for each first NF node (30) of the plurality of first NF nodes (30, 70, 90), the priority information assigned to the first NF node (30) is indicative of a priority with which the first NF node (30) is to be selected to provide a service relative to at least one other first NF node (70, 90) of the plurality of first NF nodes (30, 70, 90) and the priority information is assigned to the first NF node (30) based on one or more criteria of the plurality of criteria that the first NF node (30) meets and the position of the one or more criteria in the order of importance of the plurality of criteria.

Embodiment 21. A method according to Embodiment 20, wherein:
the first message (112, 420, 524, 726) comprises an array and the array comprises the information indicative of the plurality of criteria and the order of importance of the plurality of criteria,
   wherein each item of the array comprises a different criterion of the plurality of criteria and the plurality of criteria are ordered in the array according to their importance.

Embodiment 22. A method according to Embodiment 20 or 21, wherein:
the plurality of criteria comprise any one or more of:
   a criterion indicative that first NF nodes (30, 70, 90) located at a predefined location are preferred;
   a criterion indicative that first NF nodes (30, 70, 90) serving a predefined tracking area identity, TAI, are preferred;
   a criterion indicative that a predefined instance of first NF nodes (30, 70, 90) are preferred;
   a criterion indicative that first NF nodes (30, 70, 90) supporting a predefined application programming interface, API, version of the service are preferred;
   a criterion indicative that first NF nodes (30, 70, 90) serving a full public land mobile network, PLMN, are preferred;
   a criterion indicative that first NF nodes (30, 70, 90) supporting one or more predefined vendor specific features for the service are preferred; and
   a criterion indicative that first NF nodes (30, 70, 90) supporting one or more predefined vendor specific features for the first NF nodes are preferred.

Embodiment 23. A method according to any of Embodiments 20 to 22, the method comprising:
receiving a second message (420, 524) from the network node (20),
   wherein the second message (420, 524) comprises:
      the information indicative of the plurality of criteria and the order of importance of the plurality of criteria; and/or
      information indicative of the plurality of first NF nodes (30, 70, 90) for providing the service and, for each first NF node (30) of the plurality of first NF nodes (30, 70, 90), the priority information assigned to the first NF node (30).

Embodiment 24. A method according to Embodiment 23, wherein:
the second message (420, 524) is a first subscription request; and
the first subscription request (420) is a request for the NRF node (60) to notify the network node (20) of updates to a profile of any first NF nodes (30) of the plurality of first NF nodes (30, 70, 90); or
the first subscription request (524) is a request for the NRF node (60) to notify the network node (20) of updates to the priority information assigned to any first NF nodes (30) of the plurality of first NF nodes (30, 70, 90).

Embodiment 25. A method according to Embodiment 24, wherein:
the first subscription request (524) is separate from a second subscription request (520); and
the second subscription request (520) is a request for the NRF node (60) to notify the network node (20) of updates to a profile of any first NF nodes (30) of the plurality of first NF nodes (30, 70, 90).

Embodiment 26. A method according to any of Embodiments 20 to 22, wherein:
the first message (112) is a discovery request; and
the discovery request is a request for information indicative of the plurality of first NF nodes (30, 70, 90) for providing the service.

Embodiment 27. A method according to any of Embodiments 20 to 22, wherein:
the first message (420) is a subscription request; and
the subscription request is a request for the NRF node (60) to notify the network node (20) of updates to a profile of any first NF nodes (30) of the plurality of first NF nodes (30, 70, 90).

Embodiment 28. A method according to any of Embodiments 20 to 22, wherein:
the first message (524) is a first subscription request; and
the first subscription request (524) is a request for the NRF node (60) to notify the network node (20) of updates to the priority information assigned to any first NF nodes (30) of the plurality of first NF nodes (30, 70, 90).

Embodiment 29. A method according to Embodiment 28, wherein:
the first subscription request (524) comprises information indicative of the plurality of first NF nodes (30, 70, 90) for providing the service.

Embodiment 30. A method according to Embodiment 28 or 29, wherein:
the first subscription request (524) is separate from a second subscription request (520); and
the second subscription request (520) is a request for the NRF node (60) to notify the network node (20) of updates to a profile of any first NF nodes (30) of the plurality of first NF nodes (30, 70, 90).

Embodiment 31. A method according to any of Embodiments 27 to 30, the method comprising:
storing (424, 528) any or more of:
   the priority information;
   the information indicative of the plurality of criteria and the order of importance of the plurality of criteria; and
   information indicative of the plurality of first NF nodes (30, 70, 90) for providing the service.

Embodiment 32. A method according to any of Embodiments 20 to 22, wherein:
the first message (726) comprises an identifier; and
the identifier is the information indicative of the plurality of criteria and the order of importance of the plurality of criteria.

Embodiment 33. A method according to Embodiment 32, wherein:
the information indicative of the plurality of criteria and the order of importance of the plurality of criteria is an identity of a resource of the NRF (60) at which the information indicative of the plurality of criteria and the order of importance of the plurality of criteria is stored.

Embodiment 34. A method according to any of Embodiments 32 or 33, the method comprising:
initiating transmission of a third message (718) comprising the identifier towards the network node (20).

Embodiment 35. A method according to Embodiment 34, wherein:
the third message (718) is a discovery response; and
the discovery response comprises information indicative of the plurality of first NF nodes (30, 70, 90) for providing the service and information indicative that the priority information has been assigned to the plurality of first NF nodes (30, 70, 90).

Embodiment 36. A method according to any of Embodiments 32 to 35, wherein:
the identifier is a uniform resource identifier, URI.

Embodiment 37. A method according to any of Embodiments 32 to 36, the method comprising:
receiving a discovery request (712) from the network node (20),
   wherein the discovery request (712) is a request for information indicative of the plurality of first NF nodes (30, 70, 90) for providing the service, and
   wherein the discovery request (712) comprises information indicative that the network node (20) is to be subscribed to updates to the priority information assigned to any first NF nodes (30) of the plurality of first NF nodes (30, 70, 90).

Embodiment 38. A method according to Embodiment 37, the method comprising:
storing (716), in a memory (64) of the NRF node (60), any one or more of:
   the information indicative of the plurality of first NF nodes (30, 70, 90) for providing the service; and
   the information indicative of the plurality of criteria and the order of importance of the plurality of criteria.

Embodiment 39. A method according to any of Embodiments 27 to 38, wherein:
assigning (430, 534, 736) the priority information to the plurality of first NF nodes (30, 70, 90) comprises:
   modifying priority information previously assigned to the plurality of first NF nodes (30, 70, 90).

Embodiment 40. A method according to any of Embodiments 27 to 39, wherein:
the priority information is assigned in response to an update to a profile of one or more first NF nodes (30) of the plurality of first NF nodes (30, 70, 90) or in response to another trigger.

Embodiment 41. A method according to Embodiment 40, wherein:
the update to the profile comprises any one or more of:
   an update to one or more attributes in the profile, wherein the assigned priority information is based on the one or more attributes; and
   an update to priority information in the profile, wherein the assigned priority information is based on the priority information in the profile.

Embodiment 42. A method according to any of Embodiments 20 to 41, the method comprising:
receiving a discovery request (822) from the network node (20),
   wherein the discovery request is a request for information indicative of an alternative plurality of first NF nodes (30, 70, 90) for providing the service and comprises the information indicative of the plurality of criteria and the order of importance of the plurality of criteria.

Embodiment 43. A method according to any of Embodiments 20 to 42, wherein:
the network node is a second NF node (20) of a service consumer; or
the network node is a first service communication proxy, SCP, node that is configured to operate as an SCP between the second NF node (20) and the NRF node (60).

Embodiment 44. A method for prioritising a plurality of first NF nodes (30, 70, 90) of at least one service producer in a network, wherein the method is performed by a network repository function, NRF, node (60), the method comprising:
initiating transmission of a fifth message (116, 432, 540, 742) towards a network node (20),
   wherein the fifth message (116, 432, 540, 742) comprises priority information assigned to the plurality of first NF nodes (30, 70, 90),
   wherein, for each first NF node (30) of the plurality of first NF nodes (30, 70, 90), the priority information assigned to the first NF node (30) is indicative of a priority with which the first NF node (30) is to be selected to provide a service relative to at least one other first NF node (70, 90) of the plurality of first NF nodes (30, 70, 90) and the priority information is assigned to the first NF node (30) based on one or more criteria of the plurality of criteria that the first NF node (30) meets and the position of the one or more criteria in the order of importance of the plurality of criteria.

Embodiment 45. A method according to Embodiment 44, wherein:
the plurality of criteria comprise any one or more of:
   a criterion indicative that first NF nodes (30, 70, 90) located at a predefined location are preferred;
   a criterion indicative that first NF nodes (30, 70, 90) serving a predefined tracking area identity, TAI, are preferred;
   a criterion indicative that a predefined instance of first NF nodes (30, 70, 90) are preferred;
   a criterion indicative that first NF nodes (30, 70, 90) supporting a predefined application programming interface, API, version of the service are preferred;
   a criterion indicative that first NF nodes (30, 70, 90) serving a full public land mobile network, PLMN, are preferred;
   a criterion indicative that first NF nodes (30, 70, 90) supporting one or more predefined vendor specific features for the service are preferred; and
   a criterion indicative that first NF nodes (30, 70, 90) supporting one or more predefined vendor specific features for the first NF nodes are preferred.

Embodiment 46. A method according to Embodiment 44 or 45, wherein:
the fifth message (116) is a discovery response; and
the discovery response comprises information indicative of the plurality of first NF nodes (30, 70, 90) for providing the service and information indicative that the priority information has been assigned to the plurality of first NF nodes (30, 70, 90).

Embodiment 47. A method according to Embodiment 44 or 45, wherein:
the fifth message (432) is a subscription response; and
the subscription response comprises information indicative of an update to a profile of one or more first NF nodes (30) of the plurality of first NF nodes (30, 70, 90).

Embodiment 48. A method according to Embodiment 44 or 45, wherein:
the fifth message (540, 742) is a first subscription response; and
the first subscription response (540, 742) comprises information indicative of an update to the priority information assigned to one or more first NF nodes (30) of the plurality of first NF nodes (30, 70, 90).

Embodiment 49. A method according to Embodiment 48, wherein:
the first subscription response (540, 742) is separate from a second subscription response (738, 536); and
the second subscription response (738, 536) comprises information indicative of an update to a profile of one or more first NF nodes (30) of the plurality of first NF nodes (30, 70, 90).

Embodiment 50. A method according to any of Embodiments 44 to 49, the method comprising:
initiating transmission of a fourth message (810, 818) towards the network node (20),
   wherein the fourth message (810, 818) comprises information indicative that the network node (20) is to initiate transmission of a discovery request towards the NRF node (60), and
   wherein the discovery request is a request for information indicative of an alternative plurality of first NF nodes (30, 70, 90) for providing the service.

51. A method according to any of Embodiments 44 to 50, wherein:
the network node is a second NF node (20) of a service consumer; or
the network node is a first service communication proxy, SCP, node that is configured to operate as an SCP between the second NF node (20) and the NRF node (60).

Embodiment 52. A method for prioritising a plurality of first NF nodes (30, 70, 90) of at least one service producer in a network, wherein the method is performed by a network node (20), the method comprising:
receiving a fifth message (116, 432, 540, 742) from a network repository function, NRF, node (60),
   wherein the fifth message (116, 432, 540, 742) comprises priority information assigned to the plurality of first NF nodes (30, 70, 90),
   wherein, for each first NF node (30) of the plurality of first NF nodes (30, 70, 90), the priority information assigned to the first NF node (30) is indicative of a priority with which the first NF node (30) is to be selected to provide a service relative to at least one other first NF node (70, 90) of the plurality of first NF nodes (30, 70, 90) and the priority information is assigned to the first NF node (30) based on one or more criteria of the plurality of criteria that the first NF node (30) meets and the position of the one or more criteria in the order of importance of the plurality of criteria.

Embodiment 53. A method according to Embodiment 52, the method comprising:
selecting (118) a first NF node (30) from the plurality of first NF nodes (30, 70, 90) to provide the service,
   wherein the first NF node (30) is selected based on the priority information.

Embodiment 54. A method according to Embodiment 52 or 53, wherein:
the priority information assigned to the selected first NF node (30) is indicative that a priority with which the selected first NF node (30) is to be selected is higher than a priority with which the other first NF nodes (70, 90) are to be selected.

Embodiment 55. A method according to any of Embodiments 52 to 54, wherein:
the plurality of criteria comprise any one or more of:
   a criterion indicative that first NF nodes (30, 70, 90) located at a predefined location are preferred;
   a criterion indicative that first NF nodes (30, 70, 90) serving a predefined tracking area identity, TAI, are preferred;
   a criterion indicative that a predefined instance of first NF nodes (30, 70, 90) are preferred;
   a criterion indicative that first NF nodes (30, 70, 90) supporting a predefined application programming interface, API, version of the service are preferred;
   a criterion indicative that first NF nodes (30, 70, 90) serving a full public land mobile network, PLMN, are preferred;
   a criterion indicative that first NF nodes (30, 70, 90) supporting one or more predefined vendor specific features for the service are preferred; and
   a criterion indicative that first NF nodes (30, 70, 90) supporting one or more predefined vendor specific features for the first NF nodes are preferred.

Embodiment 56. A method according to any of Embodiments 52 to 55, wherein:
the fifth message (116) is a discovery response; and
the discovery response comprises information indicative of the plurality of first NF nodes (30, 70, 90) for providing the service and information indicative that the priority information has been assigned to the plurality of first NF nodes (30, 70, 90).

Embodiment 57. A method according to any of Embodiments 52 to 55, wherein:
the fifth message (432) is a subscription response; and
the subscription response comprises information indicative of an update to a profile of one or more first NF nodes (30) of the plurality of first NF nodes (30, 70, 90).

Embodiment 58. A method according to any of Embodiments 52 to 55, wherein:
the fifth message (540, 742) is a first subscription response; and
the first subscription response (540, 742) comprises information indicative of an update to the priority information assigned to one or more first NF nodes (30) of the plurality of first NF nodes (30, 70, 90).

Embodiment 59. A method according to Embodiment 58, wherein:
the first subscription response (540, 742) is separate from a second subscription response (738, 536); and
the second subscription response (738, 536) comprises information indicative of an update to a profile of one or more first NF nodes (30) of the plurality of first NF nodes (30, 70, 90).

Embodiment 60. A method according to any of Embodiments 52 to 59, the method comprising:
receiving a fourth message (810, 818) from the NRF node (60),
   wherein the fourth message (810, 818) comprises information indicative that the network node (20) is to initiate transmission of a discovery request towards the NRF node (60), and
   wherein the discovery request is a request for information indicative of an alternative plurality of first NF nodes (30, 70, 90) for providing the service.

Embodiment 61. A method according to any of Embodiments 52 to 60, wherein:
the network node is a second NF node (20) of a service consumer; or
the network node is a first service communication proxy, SCP, node that is configured to operate as an SCP between the second NF node (20) and the NRF node (60).

Embodiment 62. A method performed by a system, the method comprising:
the method according to any of Embodiments 1 to 19 and/or any of Embodiments 52 to 61; and
the method according to any of Embodiments 20 to 43 and/or any of Embodiments 44 to 51.

Embodiment 63. A network node (20) comprising:
processing circuitry (22) configured to operate in accordance with any of Embodiments 1 to 19 and/or any of Embodiments 52 to 61.

Embodiment 64. A network node (20) according to Embodiment 63, wherein:
the network node (20) comprises:
   at least one memory (24) for storing instructions which, when executed by the processing circuitry (22), cause the network node (20) to operate in accordance with any of Embodiments 1 to 19 and/or any of Embodiments 52 to 61.

Embodiment 65. A network repository function, NRF, node (60) comprising:
processing circuitry (62) configured to operate in accordance with any of Embodiments 20 to 43 and/or any of Embodiments 44 to 51.

Embodiment 66. An NRF node (60) according to Embodiment 65, wherein:
the NRF node (60) comprises:
   at least one memory (64) for storing instructions which, when executed by the processing circuitry (62), cause the NRF node (60) to operate in accordance with any of Embodiments 20 to 43 and/or any of Embodiments 44 to 51.

Embodiment 67. A system comprising:
at least one network node (20) according to Embodiment 63 or 64; and
at least one NRF node (60) according to Embodiment 65 or 66.

Embodiment 68. A computer program comprising instructions which, when executed by processing circuitry, cause the processing circuitry to perform the method according to any of Embodiments 1 to 19, any of Embodiments 20 to 43, any of Embodiments 44 to 51, and/or any of Embodiments 52 to 61.

Embodiment 69. A computer program product, embodied on a non-transitory machine-readable medium, comprising instructions which are executable by processing circuitry to cause the processing circuitry to perform the method according to any of Embodiments 1 to 19, any of Embodiments 20 to 43, any of Embodiments 44 to 51, and/or any of Embodiments 52 to 61.

In some embodiments, the network node functionality and/or the NRF node functionality described herein can be performed by hardware. Thus, in some embodiments, any one or more of the network node 20 and the NRF node 60 described herein can be a hardware node. However, it will also be understood that optionally at least part or all of the network node functionality and/or the NRF node functionality described herein can be virtualized. For example, the functions performed by any one or more of the network node 20 and the NRF node 60 described herein can be implemented in software running on generic hardware that is configured to orchestrate the node functionality. Thus, in some embodiments, any one or more of the network node 20 and the NRF node 60 described herein can be a virtual node. In some embodiments, at least part or all of the network node functionality and/or the NRF node functionality described herein may be performed in a network enabled cloud.

The network node functionality and/or the NRF node functionality described herein may all be at the same location or at least some of the node functionality may be distributed.

It will be understood that at least some or all of the method steps described herein can be automated in some embodiments. That is, in some embodiments, at least some or all of the method steps described herein can be performed automatically. The method described herein can be a computer-implemented method.

Thus, in the manner described herein, there are advantageously provided improved techniques for prioritising a plurality of first NF nodes of at least one service producer in a network. The appendices define some embodiments of the disclosure.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-49. (canceled)

50. A method for prioritising a plurality of first Network Function (NF) nodes of at least one service producer in a network, wherein the method is performed by a network node and comprises:
initiating transmission of a first message towards a Network Repository Function (NRF) node;
wherein the first message comprises information indicative of a plurality of criteria and an order of importance of the plurality of criteria;
wherein the information is for use in assigning priority information to the plurality of first NF nodes; and
wherein, for each first NF node of the plurality of first NF nodes, the priority information assigned to the first NF node is indicative of a priority with which the first NF node is to be selected to provide a service relative to at least one other first NF node of the plurality of first NF nodes and the priority information is assigned to the first NF node based on one or more criteria of the plurality of criteria that the first NF node meets and the position of the one or more criteria in the order of importance of the plurality of criteria.

51. The method of claim 50, wherein the first message comprises an array and the array comprises the information indicative of the plurality of criteria and the order of importance of the plurality of criteria, and wherein each item of the array comprises a different criterion of the plurality of criteria and the plurality of criteria are ordered in the array according to their importance.

52. The method of claim 50, wherein the plurality of criteria comprises any one or more of:
a criterion indicative that first NF nodes located at a predefined location are preferred;
a criterion indicative that first NF nodes serving a predefined tracking area identity (TAI) are preferred;
a criterion indicative that a predefined instance of first NF nodes are preferred;
a criterion indicative that first NF nodes supporting a predefined application programming interface (API) version of the service are preferred;
a criterion indicative that first NF nodes serving a full public land mobile network (PLMN) are preferred;
a criterion indicative that first NF nodes supporting one or more predefined vendor specific features for the service are preferred; and
a criterion indicative that first NF nodes supporting one or more predefined vendor specific features for the first NF nodes are preferred.

53. The method of claim 50, further comprising initiating transmission of a second message towards the NRF node, wherein the second message comprises:
the information indicative of the plurality of criteria and the order of importance of the plurality of criteria; and/or
information indicative of the plurality of first NF nodes for providing the service and, for each first NF node of the plurality of first NF nodes, the priority information assigned to the first NF node.

54. The method of claim 53, wherein:
the second message is a first subscription request; and
the first subscription request is a request for the NRF node to notify the network node of updates to a profile of any first NF nodes of the plurality of first NF nodes; or
the first subscription request is a request for the NRF node to notify the network node of updates to the priority information assigned to any first NF nodes of the plurality of first NF nodes.

55. The method of claim 54, wherein:
the first subscription request is separate from a second subscription request; and
the second subscription request is a request for the NRF node to notify the network node of updates to a profile of any first NF nodes of the plurality of first NF nodes.

56. The method of claim 50, wherein:
the first message is a discovery request and the discovery request is a request for information indicative of the plurality of first NF nodes for providing the service; or
the first message is a first subscription request and the first subscription request is a request for the NRF node to notify the network node of updates to a profile of any first NF nodes of the plurality of first NF nodes; or
the first message is a second subscription request and the second subscription request is a request for the NRF node to notify the network node of updates to the priority information assigned to any first NF nodes of the plurality of first NF nodes.

57. The method of claim 56, wherein the second subscription request comprises information indicative of the plurality of first NF nodes for providing the service.

58. The method of claim 56, wherein:
the second subscription request is separate from a third subscription request; and
the third subscription request is a request for the NRF node to notify the network node of updates to a profile of any first NF nodes of the plurality of first NF nodes.

59. The method of claim 50, wherein:
the first message comprises an identifier; and
the identifier is the information indicative of the plurality of criteria and the order of importance of the plurality of criteria.

60. The method of claim 59, wherein the information indicative of the plurality of criteria and the order of importance of the plurality of criteria is an identity of a resource of the NRF node at which the information indicative of the plurality of criteria and the order of importance of the plurality of criteria is stored.

61. The method of claim 59, further comprising receiving a third message comprising the identifier from the NRF node, wherein:
the third message is a discovery response; and
the discovery response comprises information indicative of the plurality of first NF nodes for providing the service and information indicative that the priority information has been assigned to the plurality of first NF nodes.

62. The method of claim 59, further comprising:
initiating transmission of a discovery request towards the NRF node;
wherein the discovery request is a request for information indicative of the plurality of first NF nodes for providing the service; and
wherein the discovery request comprises information indicative that the network node is to be subscribed to updates to the priority information assigned to any first NF nodes of the plurality of first NF nodes.

63. The method of claim 50, further comprising:
initiating transmission of a discovery request towards the NRF node in response to receiving a fourth message from the NRF node;
wherein the fourth message comprises information indicative that the network node is to initiate transmission of a discovery request towards the NRF node; and
wherein the discovery request is a request for information indicative of an alternative plurality of first NF nodes for providing the service and comprises the information indicative of the plurality of criteria and the order of importance of the plurality of criteria.

64. A method for prioritising a plurality of first Network Function (NF) nodes of at least one service producer in a network, wherein the method is performed by a network node and comprises:
receiving a fifth message from a Network Repository Function (NRF) node;
wherein the fifth message comprises priority information assigned to the plurality of first NF nodes; and
wherein, for each first NF node of the plurality of first NF nodes, the priority information assigned to the first NF node is indicative of a priority with which the first NF node is to be selected to provide a service relative to at least one other first NF node of the plurality of first NF nodes and the priority information is assigned to the first NF node based on one or more criteria of a plurality of criteria that the first NF node meets and the position of the one or more criteria in an order of importance of the plurality of criteria.

65. The method of claim 64, further comprising selecting a first NF node from the plurality of first NF nodes to provide the service, wherein the first NF node is selected based on the priority information.

66. The method of claim 64, wherein the priority information assigned to the selected first NF node is indicative that a priority with which the selected first NF node is to be selected is higher than a priority with which the other first NF nodes are to be selected.

67. The method of claim 64, wherein the plurality of criteria comprise any one or more of:
a criterion indicative that first NF nodes located at a predefined location are preferred;
a criterion indicative that first NF nodes serving a predefined tracking area identity, TAI, are preferred;
a criterion indicative that a predefined instance of first NF nodes are preferred;
a criterion indicative that first NF nodes supporting a predefined application programming interface, API, version of the service are preferred;
a criterion indicative that first NF nodes serving a full public land mobile network, PLMN, are preferred;
a criterion indicative that first NF nodes supporting one or more predefined vendor specific features for the service are preferred; and
a criterion indicative that first NF nodes supporting one or more predefined vendor specific features for the first NF nodes are preferred.

68. The method of claim 64, wherein:
the fifth message is a discovery response and the discovery response comprises information indicative of the plurality of first NF nodes for providing the service and information indicative that the priority information has been assigned to the plurality of first NF nodes; or
the fifth message is a first subscription response and the first subscription response comprises information indicative of an update to a profile of one or more first NF nodes of the plurality of first NF nodes; or
the fifth message is a second subscription response and the second subscription response comprises information indicative of an update to the priority information assigned to one or more first NF nodes of the plurality of first NF nodes.

69. The method of claim 68, wherein:
the second subscription response is separate from a third subscription response; and
the third subscription response comprises information indicative of an update to a profile of one or more first NF nodes of the plurality of first NF nodes.

70. The method of claim 64, further comprising:
receiving a fourth message from the NRF node;
wherein the fourth message comprises information indicative that the network node is to initiate transmission of a discovery request towards the NRF node; and
wherein the discovery request is a request for information indicative of an alternative plurality of first NF nodes for providing the service.

71. A network node comprising:
processing circuitry; and
memory comprising instructions therein that, when executed by the processing circuitry, configures the network node to:
initiate transmission of a first message towards a Network Repository Function (NRF) node;
wherein the first message comprises information indicative of a plurality of criteria and an order of importance of the plurality of criteria;
wherein the information is for use in assigning priority information to a plurality of first Network Function (NF) nodes; and
wherein, for each first NF node of the plurality of first NF nodes, the priority information assigned to the first NF node is indicative of a priority with which the first NF node is to be selected to provide a service relative to at least one other first NF node of the plurality of first NF nodes and the priority information is assigned to the first NF node based on one or more criteria of the plurality of criteria that the first NF node meets and the position of the one or more criteria in the order of importance of the plurality of criteria.

72. A network node comprising:
processing circuitry; and
memory comprising instructions therein that, when executed by the processing circuitry, configures the network node to:
receive a fifth message from a Network Repository Function (NRF) node;
wherein the fifth message comprises priority information assigned to a plurality of first Network Function (NF) nodes; and
wherein, for each first NF node of the plurality of first NF nodes, the priority information assigned to the first NF node is indicative of a priority with which the first NF node is to be selected to provide a service relative to at least one other first NF node of the plurality of first NF nodes and the priority information is assigned to the first NF node based on one or more criteria of a plurality of criteria that the first NF node meets and the position of the one or more criteria in an order of importance of the plurality of criteria.
